(19) United States
(12) Patent Application Publication
(10) Pub. No.: US 2010/0310927 A1
(43) Pub. Date: Dec. 9, 2010

(54) CURRENT COLLECTOR TERMINAL PLATE FOR SECONDARY BATTERY, SECONDARY BATTERY, AND METHOD FOR PRODUCING SECONDARY BATTERY

(76) Inventors: Tadashi Imai, Osaka (JP); Takashi Nonoshita, Osaka (JP); Kiyomi Kozuki, Osaka (JP); Yasushi Hirakawa, Osaka (JP); Seiichi Kato, Osaka (JP)

Correspondence Address: MCDERMOTT WILL & EMERY LLP, 600 13TH STREET, NW, WASHINGTON, DC, 20005-3096, US

(21) Appl. No.: 12/745,151

(22) PCT Filed: Jan. 22, 2009
(86) PCT No.: PCT/JP2009/000235

§ 371 Date: May 27, 2010

(30) Foreign Application Priority Data
Jan. 28, 2008 (JP) 2008 016126
Jan. 28, 2008 (JP) 2008 016127
Apr. 14, 2008 (JP) 2008104436

(51) Int. Cl. H01M 10/02; H01M 2/14; H01M 2/08; H01M 10/04

(52) U.S. Cl. 429/174; 429/122; 429/246; 29/623.1; 29/623.5

(57) ABSTRACT

A current collector terminal plate comprising a plate-shaped conductive material is used. The conductive material has an expected welding portion that melts with priority. The conductive material has, for example, a bent portion forming a protrusion on one side and a depression on the other side and a flat portion, and the expected welding portion includes the bent portion. The bent portion has a pair of upstanding portions raised from the flat portion and a bent top portion extending continuously from the pair of upstanding portions.

### TECHNICAL FIELD

The invention relates to the field of secondary batteries such as lithium ion secondary batteries and nickel-metal hydride storage batteries.

### BACKGROUND ART

As portable electronic devices are becoming smaller, there is an increasing demand for secondary batteries that are compact and light-weight and provide high power. Among them, lithium ion secondary batteries and nickel-metal hydride storage batteries are superior in the resistance to vibration and impact, and are also receiving attention as the power source for cordless power tools, motor assisted bicycles, and hybrid vehicles, which require large current.

In the case of secondary batteries requiring large current, each of the positive electrode and the negative electrode has, along the longitudinal direction, an edge portion where the positive electrode core member or negative electrode core member is exposed. These positive and negative electrodes are laminated or wound with a separator interposed therebetween, to form an electrode assembly. The electrode assembly is formed so that the exposed edge portion of the positive electrode core member protrudes from one end face thereof, while the exposed edge portion of the negative electrode core member protrudes from the other end face. A disc-like current collector terminal plate is connected to each exposed edge portion by welding. However, there is variation in the height of the exposed edge portion of the electrode core member protruding from the end face of the electrode assembly. It is thus difficult to evenly connect the current collector terminal plate to the exposed edge portion of the electrode core member. If the connecting strength is not sufficient, the resistance of the battery to vibration and impact decreases.

Patent Document 1 proposes welding a filter and a bottom cover to an electrode assembly in advance before inserting the electrode assembly into a battery case (see FIGS. 5 and 6 of Patent Document 1). The battery of Patent Document 1 is produced by connecting the exposed edge portion of the positive electrode core member to the filter with an electrolyte injection hole, connecting the exposed edge portion of the negative electrode core member to the bottom cover, and thereafter inserting the electrode assembly into the hollow cylindrical battery case. The open edge of the battery case is bent inward, while the outer edge of the filter is bent outward to form a protruded portion. The protruded portion of the filter engages with the bent portion of the open edge of the battery case with an insulating gasket therebetween. The injection hole is closed with a valve, and the valve is fixed by a cap-shaped terminal.

Patent Document 2 proposes laminating the exposed edge portions of an electrode core member protruding from an end face of an electrode assembly to form thickened portions (see FIG. 6 of Patent Document 2). A current collector terminal plate with a plurality of slits (cut-away portions) is disposed on the electrode assembly so that the thickened portions intersect with the peripheral portions of the slits. Thereafter, a welding electrode is disposed near the peripheral portion of each slit, and the peripheral portion of the slit is welded to the thickened portion (see FIG. 2 of Patent Document 2). As a result, a plurality of connecting portions are secured.

Patent Document 3 proposes the use of a current collector terminal plate with a plurality of bridging portions that intersect with such thickened portions at right angles. The bridging portions are welded to the thickened portions (see FIG. 21 of Patent Document 3).

### Patent Document 1: Japanese Laid-Open Patent Publication No. 2004-71453

### Patent Document 2: Japanese Laid-Open Patent Publication No. 2003-36834

### Patent Document 3: Japanese Laid-Open Patent Publication No. 2002-100340

### DISCLOSURE OF THE INVENTION

### Problem to be Solved by the Invention

In Patent Document 1, if there is unevenness in the height of the exposed edge portion of the positive electrode core member protruding from one end face of the electrode assembly and the exposed edge portion of the negative electrode core member protruding from the other end face, the electrical connection between the filter or bottom cover and the electrode core member is not stable. Where the height of the protruding core member is high, the core member is connected to the current collector terminal plate, but where the height is low, the core member is not connected.

In Patent Document 2 and Patent Document 3, in the case of a wound electrode assembly, a process for forming the thickened portions of the electrode core member becomes necessary. In the case of a cylindrical battery, in particular, a complicated bending process becomes necessary for forming the thickened portions of the electrode core member. Thus, breakage of the electrode core member due to bending tends to occur, and electrical connection is not stable.

Also, in all of these proposals, it is necessary to heat the electrode core member and the current collector terminal plate or filter to their melting points or higher for melting in order to connect them. Hence, to avoid the influence of heat in the vicinity of the connecting portions, extra space becomes necessary in consideration of heat conduction. This becomes a hindrance to space saving of the battery structure and high capacity.

### Means for Solving the Problem

An object of the invention is to provide a secondary battery which allows stable connection even when the height of an electrode core member protruding from an end face of an electrode assembly is not even, without the need to form thickened portions of the electrode core member. Another object of the invention is to provide a secondary battery which allows an electrode core member and a current collector terminal plate to be welded at low temperature, without the need to consider the influence of heat in the vicinity of connecting portions, thereby facilitating space saving.

The invention relates to a current collector terminal plate for a secondary battery, including a plate-shaped conductive material, the conductive material having an expected welding portion that melts with priority. The expected welding portion is configured to melt with higher priority than the other portions of the conductive material.

The current collector terminal plate for a secondary battery of the invention has, for example, the following embodiments.

(1) An embodiment (hereinafter “first embodiment”) in which the conductive material has a bent portion forming a protrusion on one side and a depression on the other side and a flat portion, and the expected welding portion includes the bent portion.

The bent portion preferably has a pair of upstanding portions raised from the flat portion and a bent top portion extending continuously from the pair of upstanding portions.

A gap is preferably formed between the pair of upstanding portions.

A groove for limiting the melting range of the bent portion is preferably formed on each of the pair of upstanding portions or on the flat portion near each of the pair of upstanding portions.

The cross-sectional shape of the groove is, for example, V shape, wedge shape, U shape, semicircular shape, rectangular shape, or trapezoidal shape.

(2) An embodiment (hereinafter “second embodiment”) in which the conductive material has a first metal portion forming a main portion and a second metal portion with a lower melting point than the first metal portion, and the expected welding portion includes the second metal portion.

Herein, the second embodiment can be further classified into, but is not limited to, the following embodiments.

(2-1) An embodiment in which the first metal portion has a depression on one side, and the second metal portion is disposed in the depression.

In this case, the first metal portion preferably has a bent portion or a pushed portion forming the depression on one side and a protrusion on the other side and a flat portion. Also, in a preferable embodiment, the bent portion has a pair of upstanding portions raised from the flat portion and a bent top portion extending continuously from the pair of upstanding portions, a gap is formed between the pair of upstanding portions, and the second metal portion is disposed in the gap.

It is noted that the pushed portion has a simpler structure than the bent portion and can be produced at low costs. A current collector terminal plate one side of which has the depression and the other side of which is flat has a simpler structure than one with a pushed portion and can be produced at low costs.

(2-2) An embodiment in which the first metal portion has a cut-away portion and the second metal portion is filled in the cut-away portion. When the second metal portion is disposed in the cut-away portion, the volume of the second metal portion can be increased, compared with when it is disposed in the depression.

(2-3) An embodiment in which the first metal portion has a through-hole in the thickness direction of the current collector terminal plate and the second metal portion is filled in the through-hole. When the second metal portion is filled in the through-hole, the strength of the current collector terminal plate can be increased, compared with when it is filled in the cut-away portion.

It is noted that in the embodiments (2-2) and (2-3), the second metal portion may protrude from the first metal portion. By causing the second metal portion to protrude, the volume of the second metal portion can be further increased.

The current collector terminal plate for a secondary battery of the invention is, for example, in the shape of a disc or a rectangle when seen from the thickness direction thereof. The conductive material preferably includes a portion made of copper, a copper alloy, aluminum, an aluminum alloy, nickel, a nickel alloy, or a nickel-plated steel plate. Aluminum, an aluminum alloy or the like is advantageously used for the positive electrode current collector terminal plate of a lithium ion secondary battery, and copper, a copper alloy or the like is advantageously used for the negative electrode current collector terminal plate of a lithium ion secondary battery. Nickel, a nickel alloy, a nickel-plated steel plate or the like is advantageously used for the current collector terminal plate of a nickel cadmium battery or a nickel-metal hydride storage battery.

The invention relates to a secondary battery precursor including: an electrode assembly including a first electrode and a second electrode which are wound or laminated with a separator interposed therebetween, the electrode assembly having a first end face and a second end face which are opposite to each other; a first current collector terminal plate to be disposed on the first end face and electrically connected to the first electrode; and a second current collector terminal plate to be disposed on the second end face and electrically connected to the second electrode. The first electrode includes a first core member and a first active material layer adhering to the first core member and has an exposed edge portion of the first core member which is to be disposed on the first end face and welded to the first current collector terminal plate. The second electrode includes a second core member and a second active material layer adhering to the second core member and has an exposed edge portion of the second core member which is to be disposed on the second end face and welded to the second current collector terminal plate. At least one of the first current collector terminal plate and the second current collector terminal plate is the above-mentioned current collector terminal plate having the expected welding portion.

The secondary battery precursor of the invention has, for example, the following embodiments.

(3) An embodiment (hereinafter “third embodiment”) in which the current collector terminal plate having the expected welding portion includes a plate-shaped conductive material, the conductive material has a bent portion forming a protrusion on one side and a depression on the other side and a flat portion, the expected welding portion includes the bent portion, and the depression faces the first end face or the second end face.

Herein, the bent portion preferably has a pair of upstanding portions raised from the flat portion and a bent top portion extending continuously from the pair of upstanding portions.

(4) An embodiment (hereinafter “fourth embodiment”) in which the current collector terminal plate having the expected welding portion is the above-mentioned current collector terminal plate including the plate-shaped conductive material, the conductive material has the first metal portion forming the main portion and the second metal portion with a lower melting point than the first metal portion, the expected welding portion includes the second metal portion, and the second metal portion faces the first end face or the second end face.

The fourth embodiment further includes, but is not limited to, the following embodiments.

(4-1) An embodiment in which the first metal portion has a depression on a face facing the first end face or the second end face and the second metal portion is disposed in the depression.

(4-2) An embodiment in which the second metal portion protrudes from the first metal portion toward the side opposite to the face facing the first end face or the second end face.

When the current collector terminal plate is in the shape of a disc when seen from the thickness direction thereof, the expected welding portions are preferably disposed radially, and when it is in the shape of a rectangle, the expected welding portions are preferably disposed in a direction intersecting with longer sides thereof.

The invention relates to a secondary battery including: an electrode assembly including a first electrode and a second electrode which are wound or laminated with a separator interposed therebetween, the electrode assembly having a first end face and a second end face which are opposite to each other; an electrolyte; a cylindrical battery case having a bottom and housing the electrode assembly and the electrolyte; a seal plate for sealing the battery case; a first current collector terminal plate disposed on the first end face and electrically connected to the first electrode; and a second current collector terminal plate disposed on the second end face and electrically connected to the second electrode. The first electrode includes a first core member and a first active material layer adhering to the first core member and has an exposed edge portion of the first core member which is disposed on the first end face and welded to the first current collector terminal plate. The second electrode includes a second core member and a second active material layer adhering to the second core member and has an exposed edge portion of the second core member which is disposed on the second end face and welded to the second current collector terminal plate. At least one of the first current collector terminal plate and the second current collector terminal plate is a deformed version of the above-mentioned current collector terminal plate having the expected welding portion, in which the expected welding portion is deformed and in contact with the exposed edge portion of the first core member or the second core member.

The secondary battery of the invention has, for example, the following embodiments.

(5) An embodiment in which the deformed version is a deformed version of the above-mentioned current collector terminal plate including the plate-shaped conductive material, the conductive material has the bent portion forming the protrusion on one side and the depression on the other side and the flat portion, the expected welding portion includes the bent portion, the other side faces the first end face or the second end face, and the bent portion is deformed and in contact with the exposed edge portion of the first core member or the second core member.

In a preferable embodiment, the bent portion has a pair of upstanding portions raised from the flat portion and a bent top portion extending continuously from the pair of upstanding portions, and a groove for limiting the melting range of the bent portion is formed on each of the pair of upstanding portions or on the flat portion near each of the pair of upstanding portions. The cross-sectional shape of the groove is preferably V shape, wedge shape, U shape, semicircular shape, rectangular shape, or trapezoidal shape.

In the above-described secondary battery, even after the expected welding portion is melted, traces of the bent portion or grooves are likely to remain. Since the grooves limit the melting range of the bent portion, the bent portion has the function of reinforcing the strength of the flat portion even after the welding is completed.

(6) An embodiment in which the deformed version is a deformed version of the above-mentioned current collector terminal plate including the plate-shaped conductive material, the conductive material has the first metal portion forming the main portion and the second metal portion with a lower melting point than the first metal portion, the expected welding portion includes the second metal portion, the second metal portion faces the first end face or the second end face, and the second metal portion is deformed and in contact with the exposed edge portion of the first core member or the second core member.

When the current collector terminal plate is in the shape of a disc when seen from the thickness direction, it is preferable that the expected welding portions be disposed radially, deformed, and in contact with the exposed edge portion of the first core member or the second core member. When it is in the shape of a rectangle, it is preferable that the expected welding portions be disposed in a direction intersecting with longer sides thereof, deformed, and in contact with the exposed edge portion of the first core member or second core member.

The invention pertains to a method for producing a secondary battery, including the steps of: (i) providing a first electrode having a first core member and a first active material layer adhering to the first core member, the first electrode having an exposed edge portion of the first core member; (ii) providing a second electrode having a second core member and a second active material layer adhering to the second core member, the second electrode having an exposed edge portion of the second core member; (iii) winding or laminating the first electrode and the second electrode with a separator interposed therebetween to form an electrode assembly having a first end face and a second end face which are opposite to each other, wherein the exposed edge portion of the first core member is disposed on the first end face and the exposed edge portion of the second core member is disposed on the second end face; (iv) disposing a first current collector terminal plate, to be electrically connected to the first electrode, on the first end face, and welding the first current collector terminal plate to the exposed edge portion of the first core member; and (v) disposing a second current collector terminal plate, to be electrically connected to the second electrode, on the second end face, and welding the second current collector terminal plate to the exposed edge portion of the second core member. At least one of the first current collector terminal plate and the second current collector terminal plate is the above-mentioned current collector terminal plate having the expected welding portion. Step (iv) or (v) includes disposing the expected welding portion so as to face the first end face or the second end face and melting the expected welding portion such that a molten material comes into contact with the exposed edge portion of the first core member or the second core member.

The method for producing the secondary battery of the invention includes, for example, the following embodiments.

(7) An embodiment in which the current collector terminal plate having the expected welding portion is the above-mentioned current collector terminal plate including the plate-shaped conductive material, the conductive material has the bent portion forming the protrusion on one side and the depression on the other side and the flat portion, the expected welding portion includes the bent portion, and the molten material is produced by disposing the depression so as to face the first end face or the second end face and melting the bent portion.

Herein, the bent portion is preferably formed by bending. That is, it is preferable to form the bent portion by bending a plate-shaped conductive material in such a manner that a protrusion is formed on one side while a depression is formed on the other side. Also, the bending is preferably performed by press working.

When the bent portion has a pair of upstanding portions raised from the flat portion and a bent top portion extending continuously from the pair of upstanding portions, it is preferable to form a gap between the pair of upstanding portions, and bring the molten material into contact with the exposed edge portion of the first core member or the second core member through the gap.

In this case, it is preferable to form a groove for limiting the melting range of the bent portion on each of the pair of upstanding portions or on the flat portion near each of the pair of upstanding portions.

(8) An embodiment in which the current collector terminal plate having the expected welding portion is the above-mentioned current collector terminal plate including the plate-shaped conductive material, the conductive material has the first metal portion forming the main portion and the second metal portion with a lower melting point than the first metal portion, the expected welding portion includes the second metal portion, and the molten material is produced by disposing the second metal portion so as to face the first end face or the second end face and melting the second metal portion.

In the production method of the invention, it is preferable to melt the expected welding portion by TIG welding.

### EFFECT OF THE INVENTION

The current collector terminal plate of the invention has an expected welding portion that melts with priority. The expected welding portion selectively melts upon welding and the molten metal quickly enters the gaps between an electrode assembly and the current collector terminal plate and the gaps between the electrode core member. Therefore, even when the height of the electrode core member protruding from an end face of the electrode assembly is uneven, there is little influence of the variation in the height, and highly reliable connection becomes easy. Also, the exposed edge portion of the electrode core member extending perpendicularly from the end face of the electrode assembly can be easily connected to the current collector terminal plate, and there is no need to form thickened portions of the electrode core member. Thus, in cylindrical, prismatic, and flat batteries, the connection area between the electrode assembly and the current collector terminal plate becomes large. As such, current collection performance improves, and connection strength also increases.

When the current collector terminal plate has a bent portion formed by bending or the like, the bent portion melts with priority. Also, when grooves are formed for limiting the melting range of the bent portion, the grooves limit the conduction of heat in the current collector terminal plate, thereby promoting the accumulation of heat in the bent portion. As a result, the flat portion of the current collector terminal plate is not heated up to the melting temperature. As such, the melting of the bent portion is promoted, and welding efficiency improves. Also, since the bent portion can be melted by small energy, there is no need to consider the influence of heat in the vicinity of the connecting portions between the current collector terminal plate and the electrode assembly. Therefore, there is no need to provide the battery with extra space, and space saving becomes possible. As a result, a high capacity secondary battery can be obtained.

When the current collector terminal plate has a second metal portion with a lower melting point on the side facing an end face of an electrode assembly, the second metal portion melts at a lower temperature with priority. Thus, the molten metal efficiently enters the gaps between the electrode assembly and the current collector terminal plate and the gaps between the electrode core member. Also, even when the height of the electrode core member protruding from the end face of the electrode assembly is uneven, the influence of the variation in the height is further reduced. Also, the exposed edge portion of the electrode core member extending perpendicularly from the end face of the electrode assembly can be easily connected to the current collector terminal plate, and there is no need to form thickened portions of the electrode core member. Further, since welding at low temperature is possible, there is no need to consider the influence of heat in the vicinity of the connecting portions between the current collector terminal plate and the electrode assembly. As a result, there is no need to provide the battery with extra space.

A current collector terminal plate that is in the shape of a disc or a rectangle when seen from the thickness direction has a shape suited for an end face of a wound or laminated electrode assembly. It is thus easy to enlarge the connection area between the end face of the electrode assembly and the current collector terminal plate. Also, in connecting the end face of the electrode assembly and the current collector terminal plate, it is effective to use TIG welding. In this case, highly reliable connection can be realized with a simple device without using a complicated mechanism. In providing the current collector terminal plate with a bent portion, it is preferable to perform press working. In this case, a current collector terminal plate with a bent portion or grooves of various shapes can be easily obtained.

### BRIEF DESCRIPTION OF THE DRAWINGS

FIG. 1 schematically illustrates the structure of a strip-like first electrode and a strip-like second electrode;

FIG. 2 is a cross-sectional view of an electrode assembly produced by winding a first electrode and a second electrode with a separator interposed therebetween, which is parallel to the winding axis;

FIG. 3 is a longitudinal sectional view of an exemplary cylindrical secondary battery;

FIG. 4A is a perspective view showing a part of an exposed edge portion of an electrode core member protruding from an end face of an electrode assembly and a current collector terminal plate;

FIG. 4B is a perspective view showing a part of the exposed edge portion of the electrode core member protruding from the end face of the electrode assembly and the current collector terminal plate welded thereto;

FIG. 5A illustrates a disc-shaped current collector terminal plate before it is welded to an end face of a cylindrical electrode assembly;

FIG. 5B illustrates the disc-shaped current collector terminal plate being welded to the end face of the cylindrical electrode assembly;

FIG. 6A illustrates a rectangular current collector terminal plate before it is welded to an end face of a prismatic electrode assembly;

FIG. 6B illustrates the rectangular current collector terminal plate being welded to the end face of the prismatic electrode assembly;

FIG. 7A illustrates the initial stage of the connection process of an exposed edge portion of an electrode core member and a current collector terminal plate;

FIG. 7B illustrates the intermediate stage of the connection process of the exposed edge portion of the electrode core member and the current collector terminal plate;

FIG. 7C illustrates the final stage of the connection process of the exposed edge portion of the electrode core member and the current collector terminal plate;

FIG. 8A is a perspective view of a part of a current collector terminal plate with grooves limiting the melting range of a bent portion;

FIG. 8B is a cross-sectional view taken along line B-B of FIG. 8A

FIG. 8C is a cross-sectional view showing a molten metal passing through the gap between a pair of upstanding portions;

FIG. 8D illustrates a state in which an expected welding portion is completely melted and the molten metal is in contact with an exposed edge portion of an electrode core member;

FIG. 9A is a perspective view of a part of another current collector terminal plate with grooves limiting the melting range of a bent portion;

FIG. 9B is a cross-sectional view taken along line B-B of FIG. 9A;

FIG. 9C is a cross-sectional view showing a molten metal passing through the gap between a pair of upstanding portions;

FIG. 9D illustrates a state in which an expected welding portion is completely melted and the molten metal is in contact with an exposed edge portion of an electrode core member;

FIG. 10 illustrates various cross-sectional shapes of grooves limiting the melting range of a bent portion;

FIG. 11A illustrates the initial stage of the connection process of an exposed edge portion of an electrode core member and another current collector terminal plate;

FIG. 11B illustrates the intermediate stage of the connection process of the exposed edge portion of the electrode core member and the current collector terminal plate;

FIG. 11C illustrates the final stage of the connection process of the exposed edge portion of the electrode core member and the current collector terminal plate;

FIG. 12A illustrates another disc-shaped current collector terminal plate before it is welded to an end face of a cylindrical electrode assembly;

FIG. 12B illustrates the disc-shaped current collector terminal plate being welded to the end face of the cylindrical electrode assembly;

FIG. 13A illustrates still another disc-shaped current collector terminal plate before it is welded to an end face of a cylindrical electrode assembly;

FIG. 13B illustrates the disc-shaped current collector terminal plate being welded to the end face of the cylindrical electrode assembly;

FIG. 14A illustrates another rectangular current collector terminal plate before it is welded to an end face of a prismatic electrode assembly;

FIG. 14B illustrates the rectangular current collector terminal plate being welded to the end face of the prismatic electrode assembly;

FIG. 15A illustrates still another rectangular current collector terminal plate before it is welded to an end face of a prismatic electrode assembly;

FIG. 15B illustrates the rectangular current collector terminal plate being welded to the end face of the prismatic electrode assembly;

FIG. 16A is a perspective view of a part of a current collector terminal plate in which the gap in a bent portion is filled with a low melting-point metal;

FIG. 16B illustrates the initial stage of the connection process of an exposed edge portion of an electrode core member and the current collector terminal plate of FIG. 16A;

FIG. 16C illustrates the final stage of the connection process of the exposed edge portion of the electrode core member and the current collector terminal plate of FIG. 16A.

FIG. 17A is a perspective view of a part of a current collector terminal plate in which the depression in a pushed portion is filled with a low melting-point metal;

FIG. 17B illustrates the final stage of the connection process of an exposed edge portion of an electrode core member and the current collector terminal plate of FIG. 17A;

FIG. 18A is a perspective view of a part of a current collector terminal plate one side of which has a depression and the other side of which is flat, wherein the depression is filled with a low melting-point metal;

FIG. 18B illustrates the final stage of the connection process of an exposed edge portion of an electrode core member and the current collector terminal plate of FIG. 18A.

FIG. 19A is a perspective view of a part of a current collector terminal plate in which a cut-away portion is filled with a low melting-point metal;

FIG. 19B illustrates the final stage of the connection process of an exposed edge portion of an electrode core member and the current collector terminal plate of FIG. 19A;

FIG. 20A is a perspective view of a part of another current collector terminal plate in which a cut-away portion is filled with a low melting-point metal;

FIG. 20B illustrates the final stage of the connection process of an exposed edge portion of an electrode core member and the current collector terminal plate of FIG. 20A;

FIG. 21A is a perspective view of a part of a current collector terminal plate in which small through-holes are filled with a low melting-point metal;

FIG. 21B illustrates the final stage of the connection process of an exposed edge portion of an electrode core member and the current collector terminal plate of FIG. 21A;

FIG. 22A is a perspective view of a part of another current collector terminal plate in which small through-holes are filled with a low melting-point metal; and

FIG. 22B illustrates the final stage of the connection process of an exposed edge portion of an electrode core member and the current collector terminal plate of FIG. 22A.

### BEST MODE FOR CARRYING OUT THE INVENTION

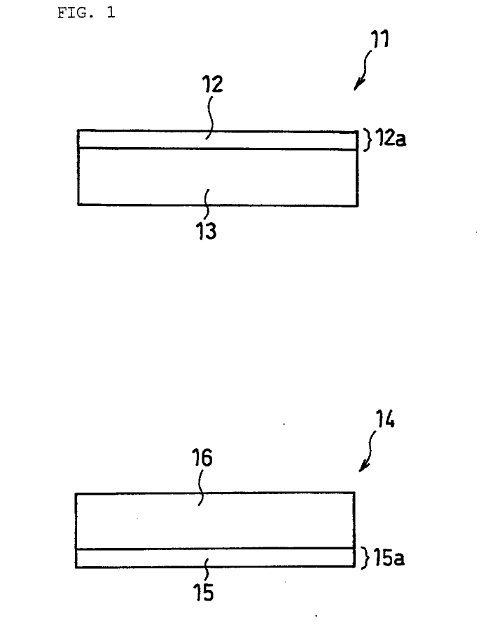

With reference to drawings, a description is given. FIG. 1 schematically illustrates the structure of a strip-like first electrode and a strip-like second electrode. A first electrode 11 includes a first core member 12 and a first active material layer 13 adhering to each side of the first core member. The first electrode 11 has, at one end along the longitudinal direction, an edge portion 12a where the first core member is exposed. Likewise, a second electrode 14 includes a second core member 15 and a second active material layer 16 adhering to each side of the second core member. The second electrode 14 has, at one end along the longitudinal direction, an edge portion 15a where the second core member is exposed. Such an electrode is formed, for example, by preparing a paste containing an electrode mixture and a dispersion medium, applying the paste onto each side of an electrode core member excluding the exposed edge portion of the electrode core member, drying the applied coating, and rolling it.

The positive electrode and the negative electrode have, along the longitudinal direction, the exposed edge portion of the positive electrode core member and the exposed edge portion of the negative electrode core member, respectively. An electrode assembly is fabricated so that the exposed edge portion of the positive electrode protrudes from one end face while the exposed edge portion of the negative electrode protrudes from the other end face. A current collector terminal plate is connected to the exposed edge portion of the electrode protruding from each end face. In the connection, the current collector terminal plate is welded at a plurality of sites. Typically, a negative electrode current collector terminal plate is resistance welded to a battery case. A positive electrode current collector terminal plate is resistance welded to a seal member via a lead. One end of the lead is connected to the positive electrode current collector terminal plate, while the other end is connected, for example, to the inner side face of the seal member.

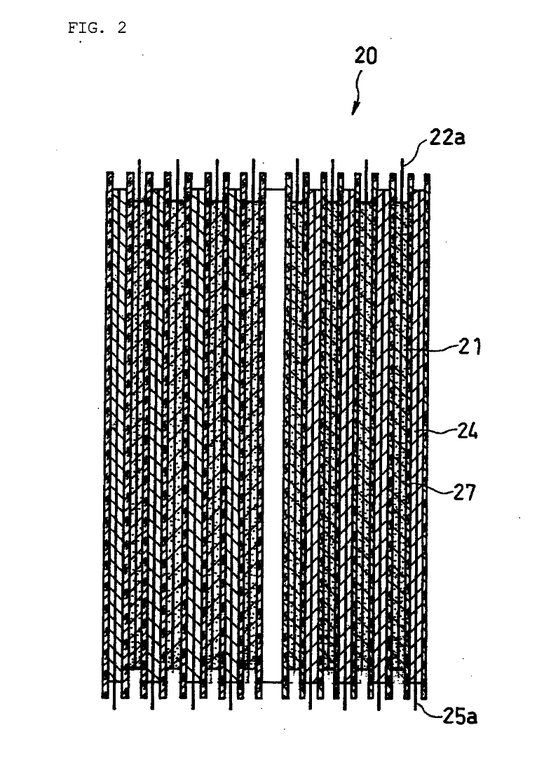

FIG. 2 schematically illustrates a longitudinal cross-section of a wound electrode assembly parallel to the winding axis. An electrode assembly 20 is laminated or wound so that an exposed edge portion 22a of a first core member protrudes from one end face thereof, while an exposed edge portion 25a of a second core member protrudes from the other end face. A separator 27 is interposed between a first electrode 21 and a second electrode 24 to prevent a short circuit, and the separator 27 is wider than these two electrodes.

A first current collector terminal plate and a second current collector terminal plate are connected to the exposed edge portion of the first core member protruding from one end face of the electrode assembly 20 and the exposed edge portion of the second core member protruding from the other end face, respectively. In the case of a cylindrical battery, such an electrode assembly is placed in a cylindrical battery case with a bottom, and then the battery case is worked so as to form a recess along the circumference of the opening of the battery case. Thereafter, a predetermined amount of an electrolyte is injected into the battery case. Subsequently, a seal plate is inserted into the opening of the battery case with a gasket interposed therebetween. The recess along the circumference of the opening protrudes inward, supporting the seal plate. The open edge is then crimped inward to seal the battery case. Typically, one current collector terminal plate is connected to the bottom of the cylindrical battery case, while the other current collector terminal plate is electrically connected to the inner face of the seal plate. In the case of a prismatic battery, typically, one current collector terminal plate is connected to the inner face of an electrode terminal of a seal plate that seals the opening of a prismatic battery case, while the other current collector terminal plate is electrically connected to the inner face of the other electrode terminal of the seal plate that seals the opening of the battery case.

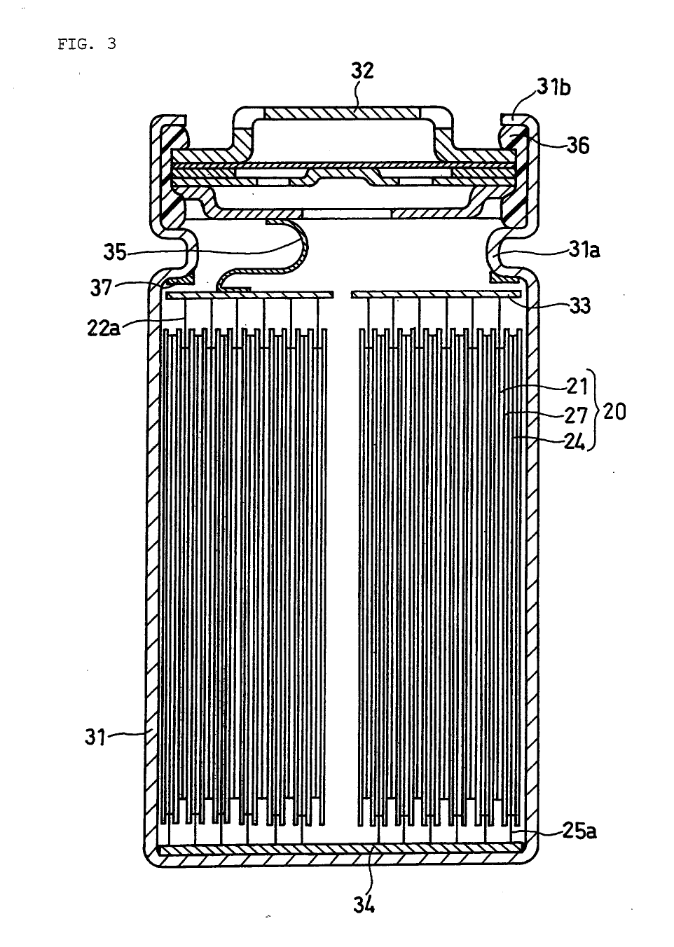

FIG. 3 is a longitudinal sectional view of an exemplary cylindrical secondary battery. A battery 30 includes: the electrode assembly 20; a cylindrical battery case 31 having a bottom and housing an electrolyte (not shown) and the electrode assembly 20; and a seal plate 32 sealing the opening of the battery case 31. A first current collector terminal plate 33 connected to the exposed edge portion 22a of the first core member is electrically connected to the inner face of the seal plate 32 with a lead 35. A second current collector terminal plate 34 connected to the exposed edge portion 25a of the second core member is electrically connected to the bottom inner face of the battery case 31. The connection between the first current collector terminal plate 33 and the lead 35 and the connection between the seal plate 32 and the lead 35 is made by laser welding and the like. A support portion 31a for supporting the seal plate 32 is provided near the opening of the battery case 31. The support portion 31a is formed by inwardly depressing the part of the battery case 31 near the opening so as to form a recess along the circumference. An insulator 37 is provided between the support portion 31a and the first current collector terminal plate 33. The edge of the seal plate 32 is fitted with a gasket 36, and an open edge 31b of the battery case 31 is crimped onto the gasket 36 for sealing.

Next, the connection between an end face of an electrode assembly and a current collector terminal plate is described in detail.

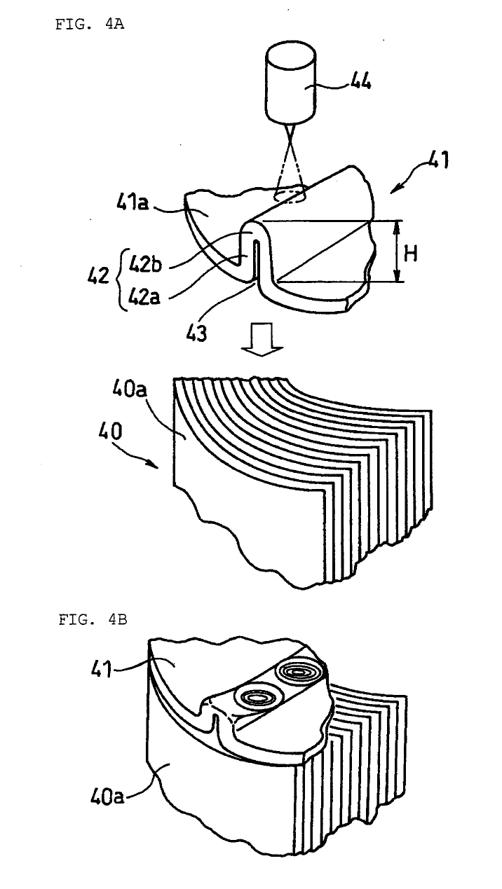

FIG. 4A is a perspective view showing a part of an exposed edge portion 40a of an electrode core member protruding from an end face of an electrode assembly 40 and a part of a current collector terminal plate 41. The electrode assembly 40 is formed by winding a strip-like first electrode and a strip-like second electrode with a strip-like separator interposed therebetween. The exposed edge portion 40a of a first core member or a second core member protrudes from one end face of the electrode assembly 40.

The current collector terminal plate 41 is made of a conductive material in the shape of a plate. The current collector terminal plate 41 has a bent portion 42 that is formed by bending along two bending lines. Due to the formation of the bent portion 42, a depression is formed on one side of the current collector terminal plate 41, while a protrusion is formed on the other side. That is, inside the protrusion is a depression. The protrusion formed by bending is in the shape of a rib, while the depression is in the shape of a groove.

The bent portion 42 has a pair of upstanding portions 42a raised from a flat portion 41a and a bent top portion 42b extending continuously therefrom. While a gap 43 between the pair of upstanding portions 42a is not particularly limited, it is preferably 0.1 mm or less. The current collector terminal plate 41 is provided with a plurality of such bent portions 42.

The current collector terminal plate 41 is placed on an end face of the electrode assembly 40. Thereafter, the bent portions 42 are melted by a TIG welding machine 44. As illustrated in FIG. 4B, simultaneously with the melting of the bent portion, the molten metal enters the gaps between the current collector terminal plate 41 and the exposed edge portion 40a of the electrode core member. As a result, the connection between the end face of the electrode assembly and the current collector terminal plate is achieved.

In terms of facilitating the connection between the electrode core member and the current collector terminal plate, it is desirable that the electrode core member and the current collector terminal plate include the same metal. For example, when the electrode core member is made of aluminum foil, it is preferable that the current collector terminal plate also include aluminum. When the electrode core member is made of copper foil, it is preferable that the current collector terminal plate also include copper. In the case of a lithium ion secondary battery, it is preferable to use copper or a copper alloy for the negative electrode core member and the current collector terminal plate for the negative electrode. Also, it is preferable to use aluminum or an aluminum alloy for the positive electrode core member and the current collector terminal plate for the positive electrode. In the case of a nickel-cadmium storage battery or a nickel-metal hydride storage battery, it is preferable to use nickel, a nickel alloy, a nickel-plated steel plate, and the like for the electrode core member and the current collector terminal plate.

When the electrode core member and the current collector terminal plate are made of copper, the positive terminal of a direct current power source for a welding machine is connected to the current collector terminal plate, while the negative terminal is connected to the torch. When the electrode core member and the current collector terminal plate are made of aluminum, it is common to use an alternating current power source. Thus, the welding machine is replaced with an alternating current one.

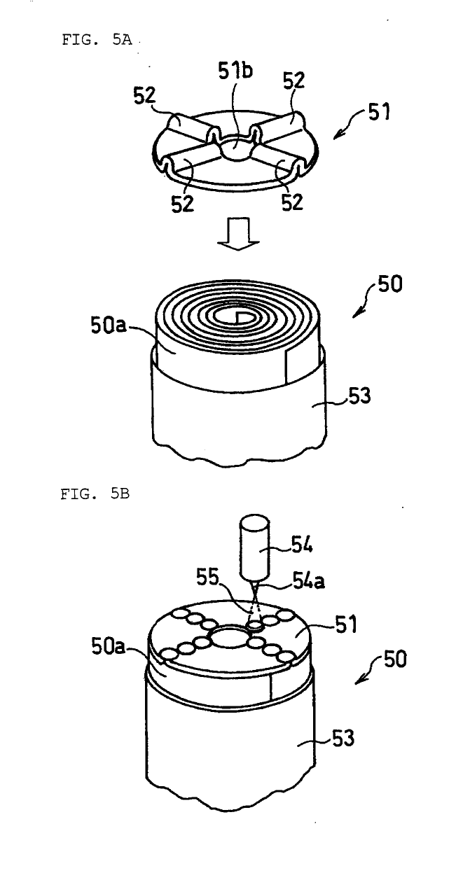

FIG. 5A and FIG. 5B show how a disc-like current collector terminal plate 51 is connected to an end face of a cylindrical electrode assembly 50. The electrode assembly 50 has a cylindrical shape whose winding axis is the central axis. An exposed edge portion 50a of an electrode core member protrudes from the end face of the electrode assembly 50. The outermost part of the electrode assembly 50 is usually covered with a separator 53. In FIG. 5A, the current collector terminal plate 51 is in the shape of a disc with a central through-hole 51b when seen from the direction of the normal thereto. The current collector terminal plate 51 has four bent portions 52 which are arranged radially at equal angles. The current collector terminal plate 51 is disposed on the end face of the electrode assembly 50.

As illustrated in FIG. 5B, when the exposed edge portion 50a of the electrode core member and the current collector terminal plate 51 are welded together, the current collector terminal plate 51 is placed on the end face of the electrode assembly 50. Then, a load is applied in the direction from the current collector terminal plate 51 toward the electrode assembly. Subsequently, the tip of a welding electrode 54a of a torch 54 of a TIG welding machine is disposed so as to face the protrusion of one of the bent portions 52. Then, spot welding is performed by producing an arc 55 at the tip of the welding electrode 54a to melt the bent portion 52 by the heat of the arc 55. This operation is performed a plurality of times from the outer side of the current collector terminal plate toward the center. Such spot welding is performed a plurality of times on all of the four bent portions 52 to complete the connection. Thereafter, the electrode assembly 50 is vertically inverted, and the same operations are performed to obtain an electrode assembly having a current collector terminal plate on each of opposing first and second end faces.

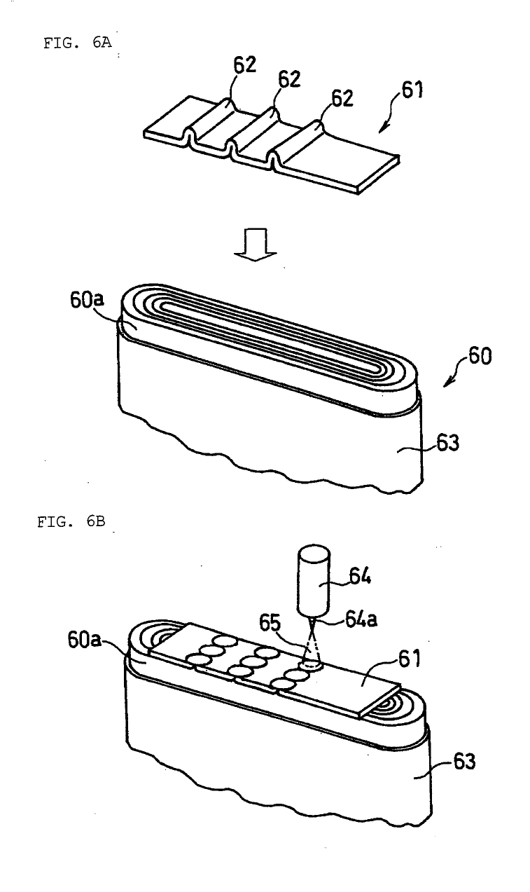

FIG. 6 shows how a (quadrangular) rectangular current collector terminal plate 61 is connected to an end face of an electrode assembly 60 of a prismatic battery. The electrode assembly 60 is in the shape of an elliptic cylinder (flat shape) whose winding axis is the central axis. An exposed edge portion 60a of an electrode core member protrudes from the end face of the electrode assembly 60. The outermost part of the electrode assembly 60 is usually covered with a separator 63. In FIG. 6A, the current collector terminal plate 61 is quadrangular when seen from the direction of the normal thereto, and has three stripe-like bent portions 62 at equal intervals. The bent portions 62 are parallel to the shorter sides of the current collector terminal plate.

As illustrated in FIG. 6B, when the exposed edge portion 60a of the electrode core member and the current collector terminal plate 61 are welded together, the current collector terminal plate 61 is placed on the end face of the electrode assembly 60. Then, a load is applied in the direction from the current collector terminal plate 61 toward the electrode assembly. Subsequently, the tip of a welding electrode 64a of a torch 64 of a TIG welding machine is disposed so as to face the protrusion of one of the bent portions 62. Then, spot welding is performed by producing an arc 65 at the tip of a TIG welding machine 64 to melt the bent portion 62 by the heat of the arc 65. This operation is performed a plurality of times from one of the longer sides of the current collector terminal plate toward the other longer side. Such spot welding is performed a plurality of times on all of the three bent portions 62 to complete the connection. Thereafter, the electrode assembly 60 is vertically inverted, and the same operations are performed to obtain an electrode assembly having a current collector terminal plate on each of opposing first and second end faces.

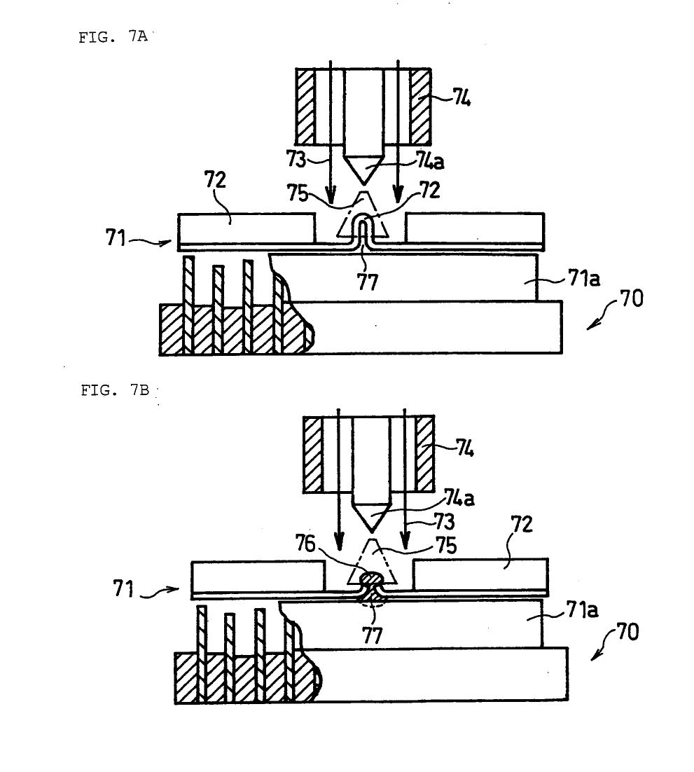

Next, referring to FIG. 7, the connection between an exposed edge portion of an electrode core member and a current collector terminal plate is more specifically described. In FIG. 7A, a current collector terminal plate 71 is placed on an end face of an electrode assembly 70, and a load is applied in the direction from the current collector terminal plate 71 toward the electrode assembly. The tip of a welding electrode 74a is disposed so as to face the protrusion of a bent portion 72. A shielding gas 73 is released from a torch 74 of a welding machine toward the bent portion 72. Thus, the heat of an arc 75 produced at the tip of the welding electrode 74a is intensively applied to the bent portion 72. When a part of the bent portion 72 is melted by the heat, molten metal 76 moves to the electrode assembly 70 side by gravity through a gap 77 between the pair of upstanding portions of the bent portion, as illustrated in FIG. 7B. The molten metal 76 then enters the gaps between the electrode assembly 70 and the current collector terminal plate 71 and the gaps between an electrode core member 70a. At this time, as illustrated in FIG. 7C, when the protrusion becomes almost flat due to melting, the heating by the arc is stopped. As a result, the molten metal 76 having almost the same volume as the bent portion enters the gaps between the electrode assembly 70 and the current collector terminal plate 71 and the gaps between the electrode core member 70a. As such, the electrode assembly 70 and the current collector terminal plate 71 are connected in a reliable manner.

If there is variation in the height of the exposed edge portion of the electrode core member protruding from the end face of the electrode assembly, gaps occur between the exposed edge portion and the current collector terminal plate. Assuming such cases, the bent portions are designed so that the amount of the molten metal 76 is sufficient. The connection area of the end face of the electrode assembly and the current collector terminal plate can be controlled by the thickness of the current collector terminal plate for forming the bent portions and the height of the protrusions. By designing the bent portions with a suitable volume, the influence of the gaps between the exposed edge portion of the electrode core member and the current collector terminal plate is eliminated. It is thus possible to obtain a secondary battery in stable connection state. By providing a plurality of connecting sites and securing a plurality of current paths, it is possible to pass a significantly large current.

When the bent portion forming a depression on one side and a protrusion on the other side is melted, the molten metal moves to the electrode assembly side through the gap between the pair of upstanding portions of the bent portion. It is particularly preferable that the bent portion have a U-shaped cross-section. Such a bent portion can be formed by bending a plate-shaped conductive material. For example, using a female die with a plurality of depressions and a male die with a plurality of protrusions corresponding to the depressions, a plate-shaped conductive material is subjected to press working. Such bending is preferably applied to a plurality of sites of the current collector terminal plate.

It takes a certain time for the molten metal to reach the exposed edge portion of the electrode core member through the gap between the pair of upstanding portions. However, if the bent portion is continuously irradiated with an arc, a large amount of heat is partially accumulated in the electrode assembly, and the separator of the electrode assembly is damaged. To avoid such a problem, it is preferable to use a TIG welding machine which can change the arc irradiation time in the range of several milliseconds to several seconds. In this case, it is preferable to perform spot welding as illustrated in FIG. 5B and FIG. 6B a plurality of times. This can reduce uneven heat distribution in the electrode assembly. Also, in TIG welding, as illustrated in FIG. 7, the molten metal is shielded by the shielding gas, so oxidation of the molten metal can be prevented. Thus, the connecting portions between the electrode assembly and the current collector terminal plate can be prevented from becoming brittle. Also, TIG welding does not require the use of a complicated mechanism. Therefore, TIG welding permits highly reliable welding with a simple device.

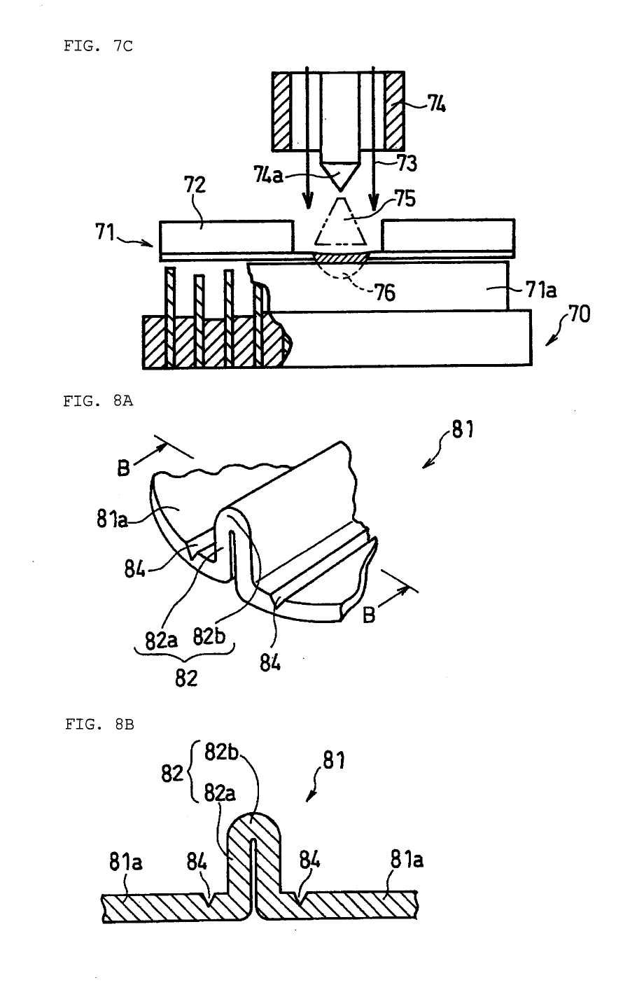

FIG. 8A is a perspective view showing a part of a current collector terminal plate according to another embodiment. A current collector terminal plate 81 has the same structure as the current collector terminal plates illustrated in FIGS. 1 to 7, except that it has grooves for limiting the melting range of a bent portion. Specifically, a bent portion 82 formed by bending has a pair of upstanding portions 82a raised from a flat portion 81a and a bent top portion 82b extending continuously therefrom. While the distance between the pair of upstanding portions is not particularly limited, it is, for example, 0.1 mm or less. The current collector terminal plate 81 is provided with a plurality of such bent portions 82. A pair of grooves 84 is formed on the flat portion 81a near the protrusion along the longitudinal direction of the rib-like protrusion. The grooves 84 perform the function of limiting the melting range of the bent portion.

FIG. 8B is a cross-sectional view of the current collector terminal plate 81 of FIG. 8A taken along line B-B. The pair of grooves 84 has a V-shaped cross-section and is symmetrical with respect to the bent portion 82. When the current collector terminal plate 81 is connected to an electrode assembly, the bent portion 82 is heated for melting from the protrusion side. Due to the formation of the pair of grooves 84 on the flat portion 81a near the protrusion, the dissipation of heat to the flat portion 81a is limited. As a result, the heat accumulation in the bent portion 82 is increased, the melting of the bent portion 82 is promoted, and efficient welding becomes possible. In particular, the heat accumulation in the top portion 82b of the bent portion is increased. The flat portion 81a is not heated up to the melting temperature.

FIG. 8C illustrates the passage of molten metal 86 through a gap 83 between the two upstanding portions of the bent portion 82. Also, FIG. 8D illustrates the pair of V-shaped grooves 84 limiting the dissipation of heat to the flat portion 81a, thereby suppressing the melting of the flat portion 81a. Since the dissipation of heat to the flat portion is suppressed, the area between the pair of grooves 84 melts. That is, the pair of grooves 84 performs not only the function of increasing the melting efficiency of the bent portion but also the function of controlling the volume of the molten metal 86. When the molten metal 86 drops on an exposed edge portion 80a of an electrode core member protruding from an end face of an electrode assembly 80, the connection between the current collector terminal plate 81 and the electrode assembly 80 is achieved. The volume of the molten metal 86 can be controlled by the position of the pair of grooves 84, the thickness of the current collector terminal plate for forming the bent portion 82, and the height of the protrusion.

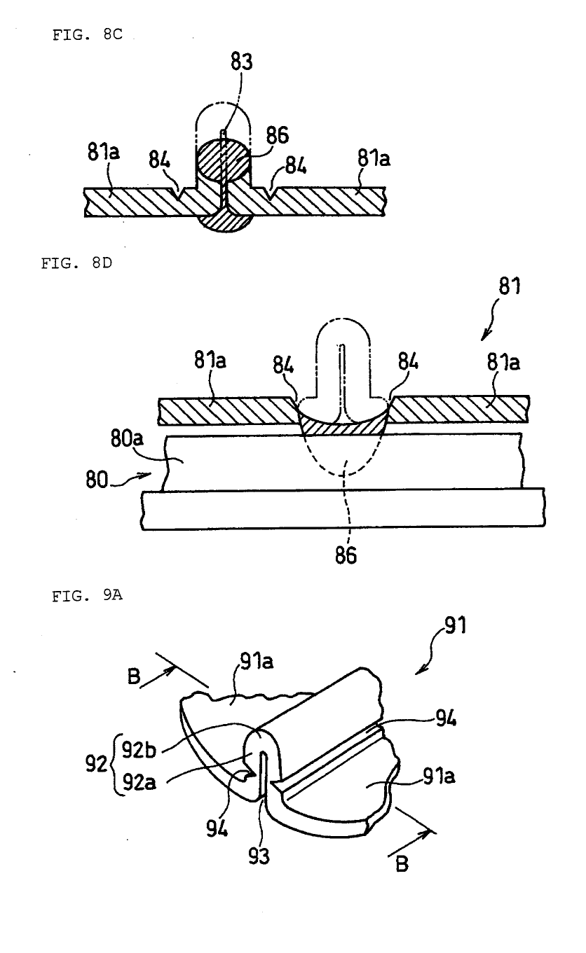

As illustrated in FIGS. 9A to 9D, a pair of grooves 94 may be formed on the bottom of a bent portion 92 of a current collector terminal plate 91. Therein, the grooves 94 are formed on the bottom of a pair of upstanding portions 92a of the bent portion so as to be opposite to each other. Due to the formation of such grooves, the heat accumulation in a top portion 92b of the bent portion 92 is further increased. As a result, heat is concentrated on the upper part of the protrusion. Hence, the volume of molten metal 96 becomes almost constant, and the amount of the molten metal 96 dropping on an exposed edge portion 90a of an electrode core member protruding from an end face of an electrode assembly 90 can be controlled accurately. Also, the current collector terminal plate and the electrode assembly are evenly connected, and variation in connection strength is reduced. Also, by providing a gap 93 between the pair of upstanding portions 92a, the molten metal can quickly move to the electrode assembly side through the gap 93. Thus, there is no need to melt the whole bent portion, and welding can be performed with small energy. As a result, deterioration of the electrode assembly excluding the connecting portions by heat can be suppressed.

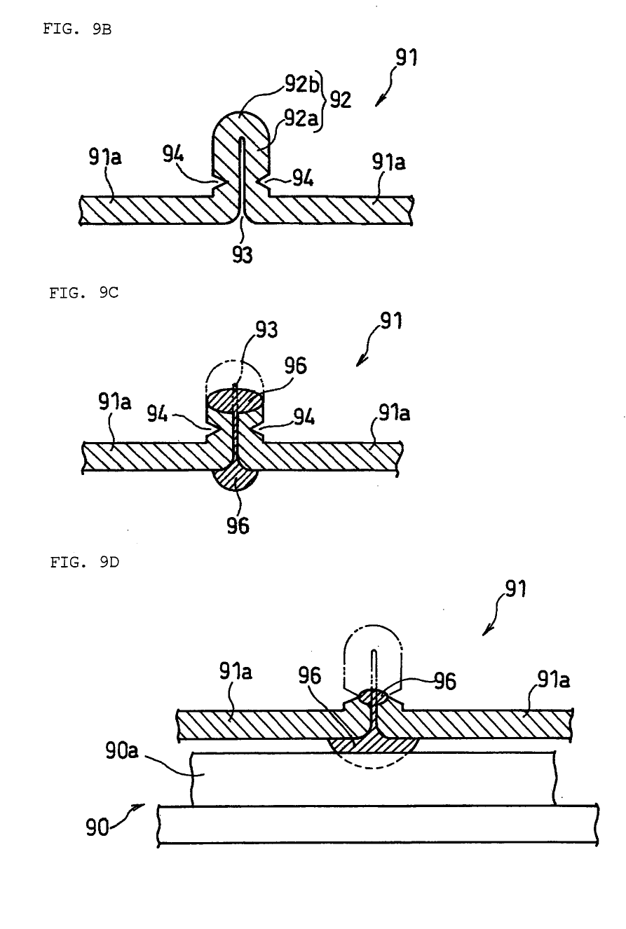

The shape of cross-section of the grooves formed on the bottom of or near the protrusion is not particularly limited. As used herein, “cross-section” refers to a cross-section perpendicular to the length direction of the grooves. Regardless of the shape of the grooves, the effect of controlling the heat conduction of the current collector terminal plate can be obtained. For example, as illustrated in FIG. 10, (a) V shape, (b) wedge shape, (c) U shape, (d) semicircular shape, (e) quadrangular (rectangular) shape, or (f) trapezoidal shape can be used. Depending on the cross-sectional shape of the grooves, it is also possible to control the dissipation of heat from the bent portion to the flat portion.

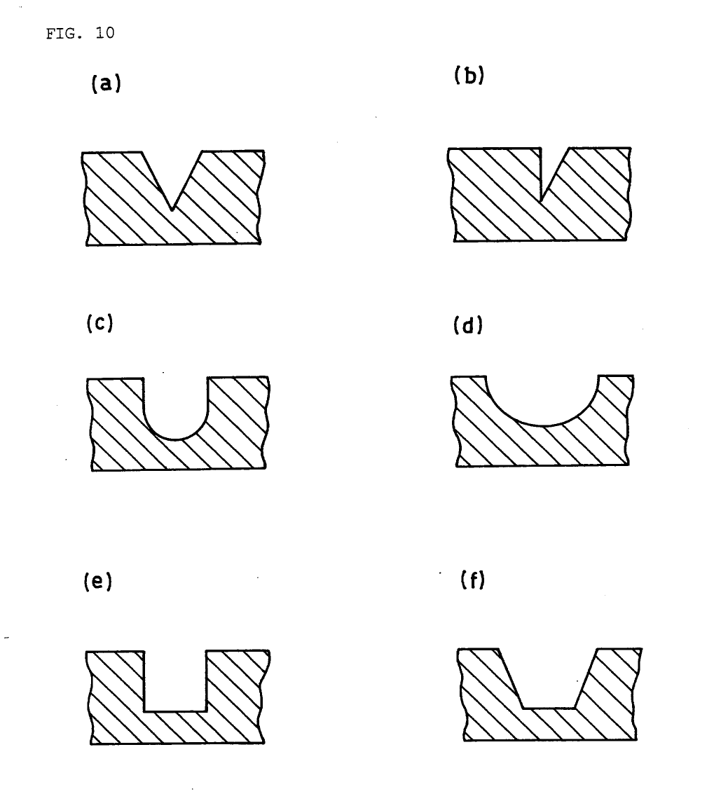

FIG. 11 illustrates how an exposed edge portion of an electrode core member and a current collector terminal plate 111 with a pair of grooves 78 are connected. FIG. 11 is the same as FIG. 7 except that the pair of grooves 78 is formed near the protrusion. As illustrated in FIG. 11A, a shielding gas 73 is released from a torch 74 of a welding machine toward a bent portion 72. The heat of an arc 75 produced at the tip of a welding electrode 74a is intensively applied to the bent portion 72 from the protrusion side. A part of the bent portion 72 is melted by the heat to form molten metal 76. As illustrated in FIG. 11B, the molten metal 76 moves to the electrode assembly 70 side through a gap 77 between a pair of upstanding portions of the bent portion. As illustrated in FIG. 11C, the area between the pair of grooves 78 is melted. Then, the molten metal 76 having the same volume as that of the area enters the gaps between the electrode assembly 70 and the current collector terminal plate 111 and the gaps between an electrode core member 70a.

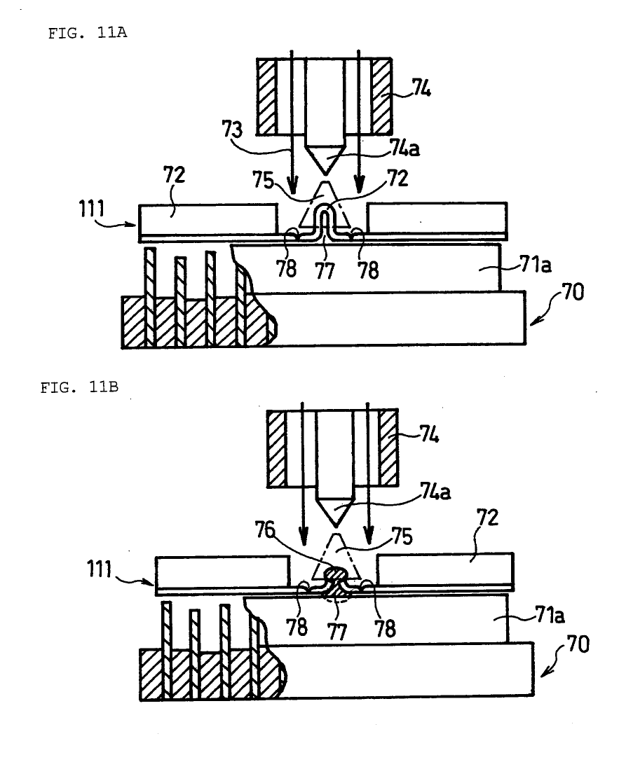

FIG. 12A and FIG. 12B illustrate how a disc-shaped current collector terminal plate 121 is connected to an end face of an electrode assembly 50 of a cylindrical battery. FIG. 12A and FIG. 12B are the same as FIG. 5A and FIG. 5B, except that the current collector terminal plate 121 has grooves 56, which are formed on a flat portion 51a near each bent portion 52 along the longitudinal direction of the protrusion.

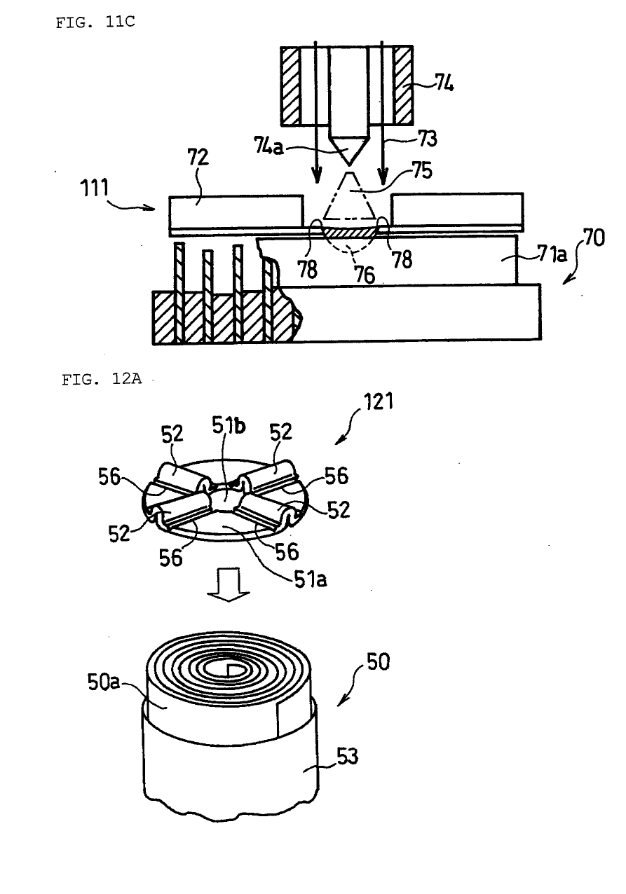

FIG. 13A and FIG. 13B show how another disc-shaped current collector terminal plate 131 is connected town end face of an electrode assembly 50 of a cylindrical battery. FIG. 13A and FIG. 13B are the same as FIG. 5A and FIG. 5B, except that the current collector terminal plate 131 has mutually opposing grooves 57, which are formed on the bottom of a pair of upstanding portions of each bent portion 52 along the longitudinal direction of the protrusion.

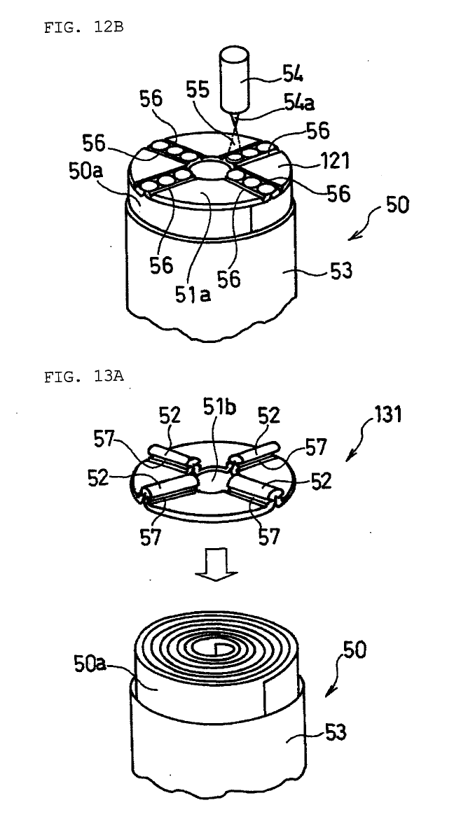

FIG. 14A and FIG. 14B illustrate how a quadrangular (rectangular) current collector terminal plate 141 is connected to an end face of an electrode assembly 60 of a prismatic battery. FIG. 14A and FIG. 14B are the same as FIG. 6A and FIG. 6B, except that the current collector terminal plate 141 has grooves 66, which are formed on a flat portion 61a near each bent portion 62 along the longitudinal direction of the protrusion.

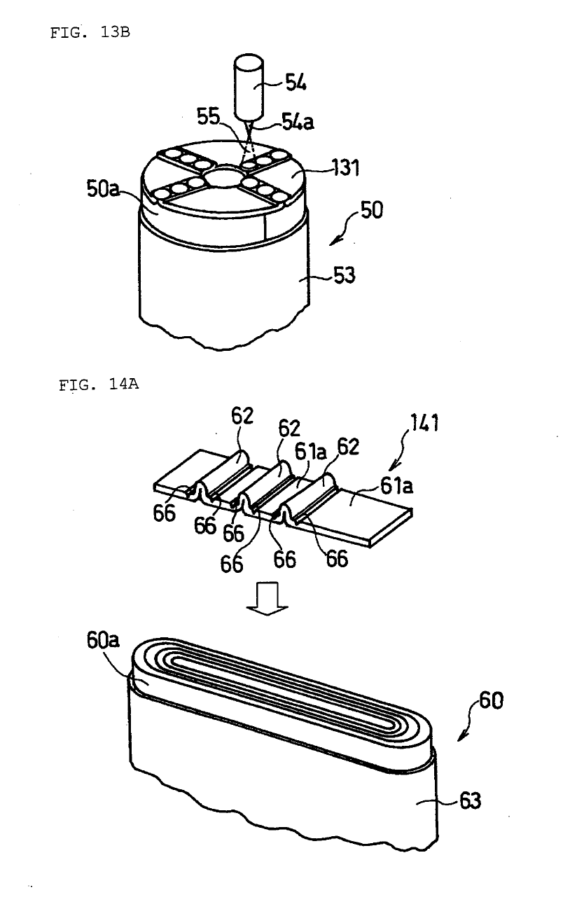

FIG. 15A and FIG. 15B illustrate how another quadrangular (rectangular) current collector terminal plate 151 is connected to an end face of an electrode assembly 60 of a prismatic battery. FIG. 15A and FIG. 15B are the same as FIG. 6A and FIG. 6B, except that the current collector terminal plate 151 has mutually opposing grooves 67, which are formed on the bottom of a pair of upstanding portions of each bent portion 62 along the longitudinal direction of the protrusion.

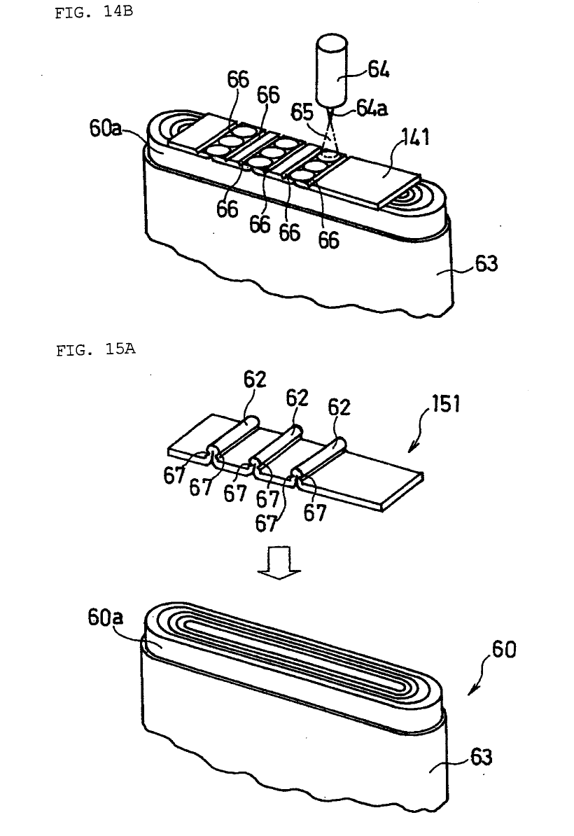

FIG. 16A is a perspective view showing a part of a current collector terminal plate according to still another embodiment.

A current collector terminal plate 161 has a bent portion 162 forming a depression on one side and a protrusion on the other side. The bent portion 162 has a pair of upstanding portions 162a raised from a flat portion 161a and a bent top portion 162b extending continuously therefrom. Inside the protrusion is a depression. The distance between the pair of upstanding portions is not particularly limited. However, the distance is preferably uniform in terms of uniformly distributing the force exerted on the current collector terminal plate and increasing current collection efficiency. A low melting-point metal portion 167 is disposed in the depression. The bent portion 162 and the flat portion 161a constitute a first metal portion, while the low melting-point metal portion 167 constitutes a second metal portion. The current collector terminal plate 161 is provided with a plurality of such low melting-point metal portions 167.

As illustrated in FIG. 16B, when the current collector terminal plate 161 is connected to an end face of an electrode assembly, the current collector terminal plate 161 is placed on an end face of an electrode assembly 160, and a load is applied in the direction from the current collector terminal plate 161 toward the electrode assembly. The tip of a welding electrode 165 is disposed so as to face the protrusion of the bent portion 162. Then, the heat of an arc 166 produced at the tip of the welding electrode 165 is applied to the bent portion 162 from the protrusion side.

Since the low melting-point metal portion 167 with a lower melting point than the bent portion 162 melts by the heat, efficient welding at low temperature becomes possible. In the welding, in addition to the low melting-point metal portion, the bent portion 162 may also be melted. However, in order to perform efficient welding at low temperature, it is desirable to make the melting point of the low melting-point metal portion constituting the second metal portion lower than the melting point of the conductive material constituting the first metal portion by 10% to 30% in ° C.

When the low melting-point metal portion 167 melts, molten metal 168 moves to the electrode assembly 160 side by gravity, as illustrated in FIG. 16C. The molten metal 168 then enters the gaps between the electrode assembly 160 and the current collector terminal plate 161 and the gaps between an electrode core member 160a. The volume of the molten metal 168 can be controlled by the volume of the low melting-point metal portion 167 or the volume of the depression of the bent portion.

In the case of a lithium ion secondary battery, the material for the low melting-point metal portion of the positive electrode current collector terminal plate is preferably aluminum alloy solder or silver solder. The material for the low melting-point metal portion of the negative electrode current collector terminal plate is preferably phosphor copper solder, copper solder, nickel solder, or the like. In the case of a nickel-cadmium storage battery or nickel-metal hydride storage battery, the material for the low melting-point metal portion of the positive and negative electrode current collector terminal plates is preferably nickel solder or the like.

The current collector terminal plate with a low melting-point metal portion has various embodiments.

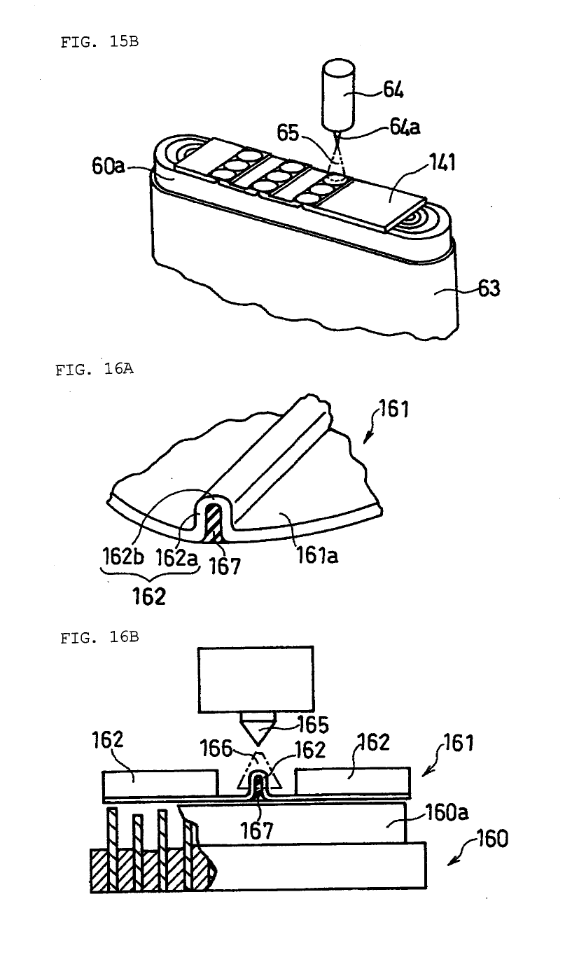

A current collector terminal plate 171 of FIG. 17A is made of a plate-shaped conductive material, and the conductive material has a pushed portion 172 forming a depression on one side and a protrusion on the other side. Such pushed portion 172 has a simpler structure than the bent portion formed by bending. Thus, a complicated bending process is not necessary, and an inexpensive current collector terminal plate can be obtained with high accuracy. A low melting-point metal portion 177 is disposed in the depression of the pushed portion 172. The current collector terminal plate 171 is provided with a plurality of such low melting-point metal portions 177. In the pushed portion 172 of FIG. 17A, the protrusion is in the shape of a rib, but the shape of the protrusion is not limited. As illustrated in FIG. 17B, when the current collector terminal plate 171 is connected to an end face of an electrode assembly, the current collector terminal plate 171 is placed on an end face of an electrode assembly 160, and the heat of an arc 166 produced at the tip of a welding electrode 165 is applied to the pushed portion 172 from the protrusion side. As a result, molten metal 178 moves to the electrode assembly 160 side by gravity.

The height of the protrusion of the pushed portion 172 is preferably 1.5 to 3 times the thickness of the conductive material constituting the current collector terminal plate. The pushed portion 172 has a pair of upstanding portions 172a raised from a flat portion 171a and a bent top portion 172b extending continuously therefrom. The angle formed by the flat portion 171a and the upstanding portion 172a is, for example, 90° to 150°. In the case of the bent portion 42 of FIG. 4A formed by bending, the angle formed by the flat portion 41a and the upstanding portion 42a is approximately 90°.

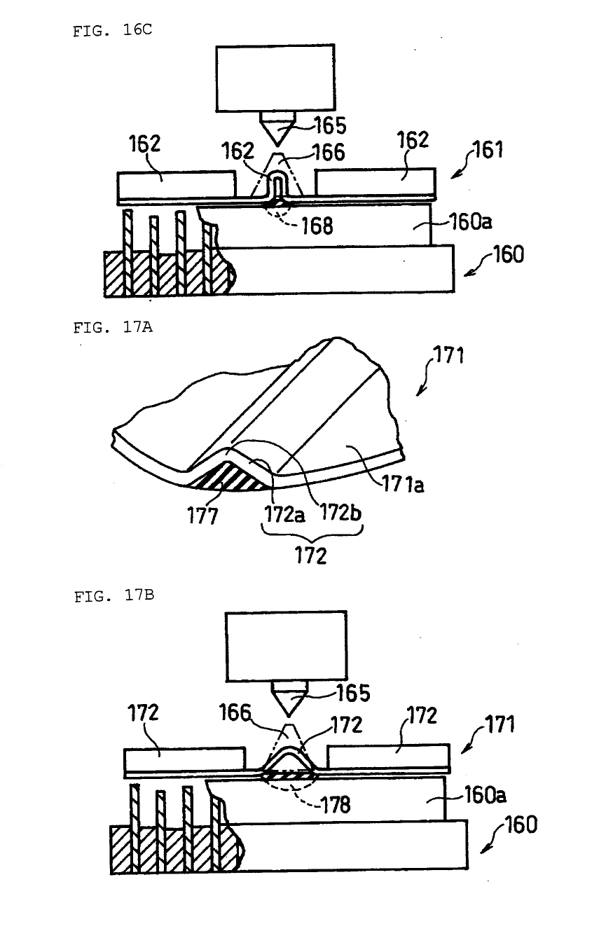

A current collector terminal plate 181 of FIG. 18A has a depression 183 on one side, but the other side is flat. Such depression 183 can be formed more easily than the pushed portion. Thus, an inexpensive current collector terminal plate can be obtained with high accuracy. The depression 183 has a low melting-point metal portion 187 therein. The current collector terminal plate 181 is provided with a plurality of such low melting-point metal portions 187. The depression 183 of FIG. 18A is in the shape of a groove, but the shape of the depression is not limited. As illustrated in FIG. 18B, when the current collector terminal plate 181 is connected to an end face of an electrode assembly, the current collector terminal plate 181 is placed on an end face of an electrode assembly 160, and the heat of an arc 166 produced at the tip of a welding electrode 165 is applied to the backside of the depression 183. As a result, molten metal 188 moves to the electrode assembly 160 side by gravity.

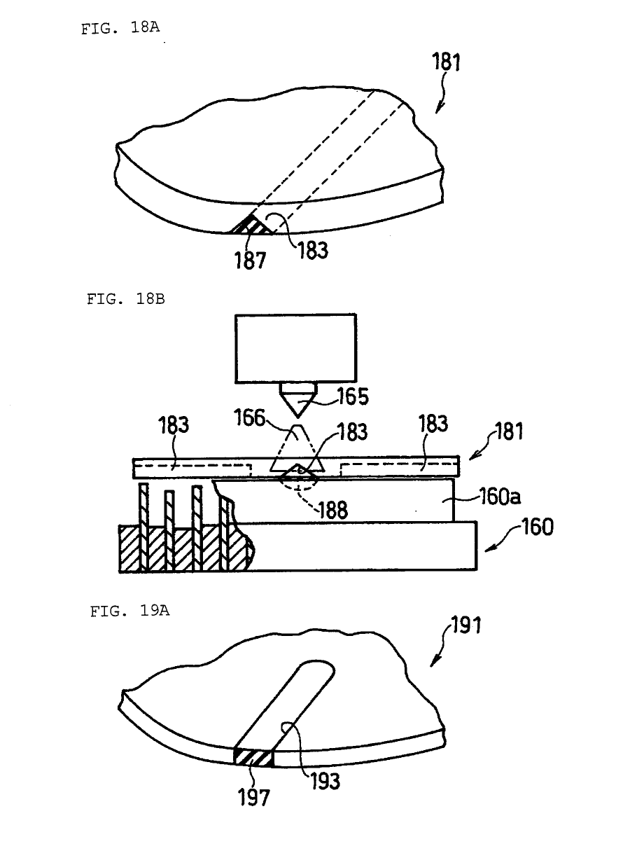

A current collector terminal plate 191 of FIG. 19A has a cut-away portion 193, and a low melting-point metal portion 197 is filled in the cut-away portion 193. When the low melting-point metal portion 197 is disposed in the cut-away portion 193, the volume of the low melting-point metal portion can be increased, compared with when the low melting-point metal portion is disposed in the depression as illustrated in FIG. 18A. As illustrated in FIG. 19B, when the current collector terminal plate 191 is connected to an end face of an electrode assembly, the current collector terminal plate 191 is placed on an end face of an electrode assembly 160, and the heat of an arc 166 produced at the tip of a welding electrode 165 is applied to the exposed surface of the low melting-point metal portion 197. Since such low melting-point metal portion has a large volume, molten metal 198 can very easily enter the gaps between the electrode assembly 160 and the current collector terminal plate 191 and the gaps between an electrode core member 160a. Thus, even when the height of the electrode core member protruding from the end face of the electrode assembly is not even, there is very little influence of the variation in the height. Therefore, stable connection becomes possible, and stable current collection from the electrode assembly is possible.

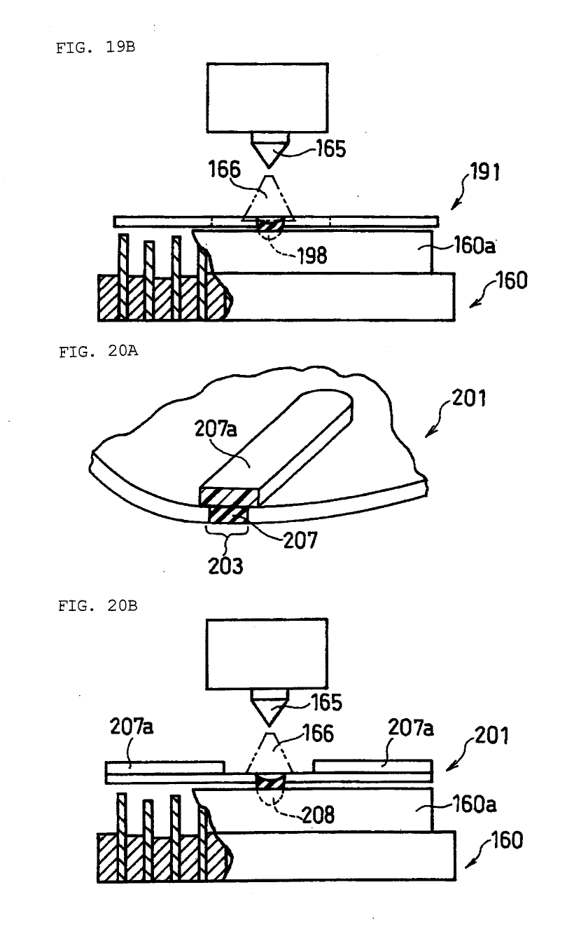

A current collector terminal plate 201 of FIG. 20A has a cut-away portion 203. A low melting-point metal portion 207 is filled in the cut-away portion 203, and the low melting-point metal portion 207 protrudes toward the side opposite to the side facing an end face of an electrode assembly. By causing the low melting-point metal portion to protrude as described above, the volume of the low melting-point metal portion can be further increased. Of the low melting-point metal portion 207, it is also possible to make the volume of a protruding portion 207a larger than that of the portion filled in the cut-away portion 203. As illustrated in FIG. 20B, when the current collector terminal plate 201 is connected to an end face of an electrode assembly, the current collector terminal plate 201 is placed on an end face of an electrode assembly 160, and the heat of an arc 166 produced at the tip of a welding electrode 165 is applied to the protruding portion 207a of the low melting-point metal portion 207. Since such low melting-point metal portion has a particularly large volume, molten metal 208 can more easily enter the gaps between the electrode assembly 160 and the current collector terminal plate 201 and the gaps between an electrode core member 160a.

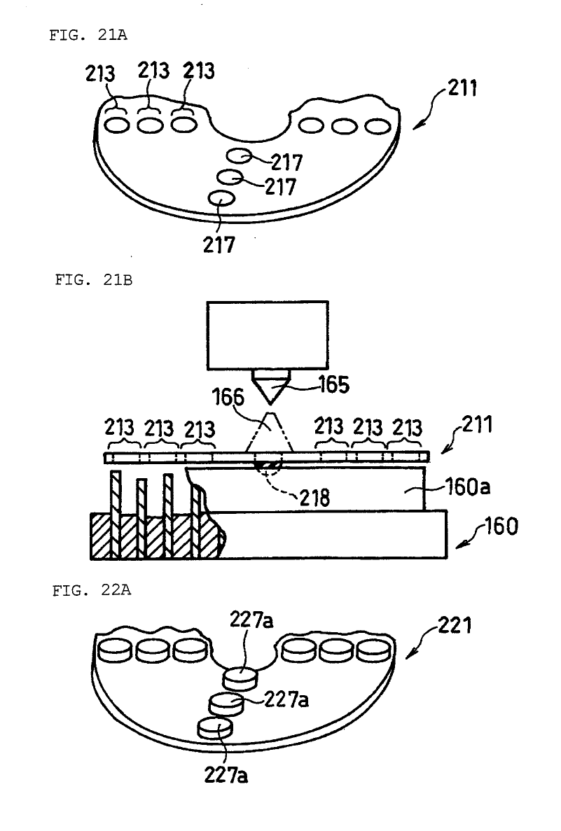

A current collector terminal plate 211 of FIG. 21A has through-holes 213 in the thickness direction, and a low melting-point metal portion 217 is filled in each through-hole 213. When the low melting-point metal portion is filled in the through-holes, the strength of the current collector terminal plate can be increased, compared with when it is filled in the cut-away portion. As illustrated in FIG. 21B, when the current collector terminal plate 211 is connected to an end face of an electrode assembly, the current collector terminal plate 211 is placed on an end face of an electrode assembly 160, and the heat of an arc 166 produced at the tip of the welding electrode 165 is applied to the exposed surface of each low melting-point metal portion 217. As a result, molten metal 218 moves to the electrode assembly 160 side by gravity. Since the strength of such current collector terminal plate can be easily secured, the arrangement of the through-holes can be freely determined. Thus, the arrangement of current collection paths can also be determined freely, and efficient arrangement for collecting large current becomes possible.

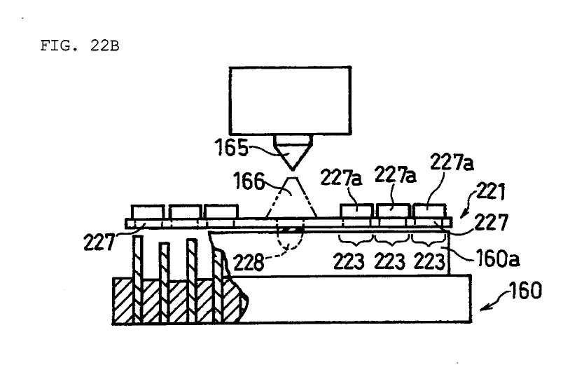

A current collector terminal plate 221 of FIG. 22A has through-holes 223 in the thickness direction, and a low melting-point metal portion 227 is filled in each through-hole 223. The low melting-point metal portion 227 protrudes toward the side opposite to the side facing an end face of an electrode assembly. By causing the low melting-point metal portion to protrude as described above, the volume of the low melting-point metal portion can be increased. Of the low melting-point metal portion 227, it is also possible to make the volume of a protruding portion 227a larger than that of the portion filled in the through-hole 223. As illustrated in FIG. 22B, when the current collector terminal plate 221 is connected to an end face of an electrode assembly, the current collector terminal plate 221 is placed on an end face of an electrode assembly 160, and the heat of an arc 166 produced at the tip of a welding electrode 165 is applied to the protruding portion 227a of the low melting-point metal portion 227. The strength of such current collector terminal plate can be easily secured, and the arrangement of the through-holes can be freely determined. In addition, since the volume of the low melting-point metal portion is large, molten metal 228 can very easily enter the gaps between the electrode assembly 160 and the current collector terminal plate 221 and the gaps between an electrode core member 160a. Therefore, the arrangement of current collection paths can be more freely determined, and stable connection becomes possible.

The invention is hereinafter described more specifically based on Examples, but the following Examples are not to be construed as limiting in any way the invention.

### Example 1

### (i) Preparation of Positive Electrode and Positive Electrode Current Collector Terminal Plate

A positive electrode mixture paste was prepared by kneading a positive electrode mixture containing lithium cobaltate serving as a positive electrode active material, an acetylene black conductive agent, and a polyvinylidene fluoride binder with a liquid dispersion medium. The positive electrode mixture paste was applied onto both sides of an aluminum foil (thickness 15 μm) serving as a positive electrode core member, dried, rolled, and cut into the shape of a strip together with the positive electrode core member, to obtain a positive electrode. One end of the positive electrode along the longitudinal direction was provided with an edge portion (width 5 mm) where the positive electrode mixture was not applied and the positive electrode core member was exposed.

A disc-shaped aluminum flat plate (thickness 0.5 mm) having an outer diameter of approximately 30 mm and a 6-mm diameter through-hole in the center was produced. This aluminum flat plate was bent by press working to form four radial bent portions with U-shaped top portions as illustrated in FIG. 4A, thereby obtaining a positive electrode current collector terminal plate. The height (H) of protrusion of each bent portion was set to 0.8 mm. The gap between the pair of upstanding portions of each bent portion was set to 0.1 mm or less.

### (ii) Preparation of Negative Electrode and Negative Electrode Current Collector Terminal Plate

A negative electrode mixture paste was prepared by kneading a negative electrode mixture containing natural graphite serving as a negative electrode active material, a polyvinylidene fluoride binder, and a polyethylene oxide thickener with a liquid dispersion medium. The negative electrode mixture paste was applied onto both sides of a copper foil (thickness 10 μm) serving as a negative electrode core member, dried, rolled, and cut into the shape of a strip together with the negative electrode core member, to obtain a negative electrode. One end of the negative electrode along the longitudinal direction was provided with an edge portion (width 5 mm) where the negative electrode mixture was not applied and the negative electrode core member was exposed.

A disc-shaped copper flat plate (thickness 0.3 mm) having an outer diameter of approximately 30 mm and a 6-mm diameter through-hole in the center was produced. This copper flat plate was bent by press working to form four radial bent portions as illustrated in FIG. 4A, thereby obtaining a negative electrode current collector terminal plate. The height (H) of protrusion of each bent portion was set to 0.5 mm. The gap between the pair of upstanding portions of each bent portion was set to 0.1 mm or less.

### (iii) Fabrication of Electrode Assembly and Welding of Current Collector Terminal Plate

The positive electrode plate and the negative electrode plate were wound with a separator comprising a polyethylene microporous film (thickness 20 μm) interposed therebetween, to form the cylindrical electrode assembly 20 (with a diameter of approximately 35 mm and a height of approximately 120 mm) of a cylindrical lithium ion secondary battery as illustrated in FIG. 2. At this time, the exposed edge portion 22a of the positive electrode core member and the exposed edge portion 25a of the negative electrode core member were allowed to protrude 3 mm from the ends of the separator on one end face and the other end face of the electrode assembly 20, respectively.

Next, the end face of the electrode assembly with the protruding exposed edge portion of the negative electrode core member was turned upward, and the negative electrode current collector terminal plate was placed on that end face. Then, a load of 500 g was applied in the direction from the negative electrode current collector terminal plate toward the electrode assembly. In this state, the protrusion of one of the bent portions of the negative electrode current collector terminal plate was melted a plurality of times from the outer side toward the center to perform spot welding (welding time: approximately 20 ms). At this time, the negative electrode current collector terminal plate was connected to the positive terminal of a direct current TIG welding machine, while the torch of the TIG welding machine was connected to the negative terminal. The space between the protrusion of the bent portion of the negative electrode current collector terminal plate and the tip of the welding electrode was set to 1 mm, and the welding electrode was faced downward. Argon gas was released from the torch of the TIG welding machine as a shielding gas at a flow rate of 5 liters per minute, to shield the welding area. The welding current was set to 110 A. The molten metal dropped under its own weight, thereby coming into contact with the exposed edge portion of the negative electrode core member and being welded thereto.

All of the four bent portions were spot welded (welding time: approximately 20 ms) a plurality of times, and the electrode assembly was vertically inverted. Thereafter, the end face of the electrode assembly with the protruding exposed edge portion of the positive electrode core member was turned upward, and the positive electrode current collector terminal plate was placed on that end face. The same operations were performed, except that the welding machine was replaced with an alternating current one and that the welding current was set to 120 A.

### Example 2

Current collector terminal plates were welded to the electrode assembly of a cylindrical lithium ion secondary battery in the same manner as in Example 1, except that the bent portions of the positive electrode current collector terminal plate and the negative electrode current collector terminal plate had protrusion heights of 1.0 mm and 0.7 mm, respectively.

### Example 3

Current collector terminal plates were welded to the electrode assembly of a cylindrical lithium ion secondary battery in the same manner as in Example 1, except that the bent portions of the positive electrode current collector terminal plate and the negative electrode current collector terminal plate had protrusion heights of 1.3 mm and 1.0 mm, respectively.

### Example 4

### (i) Preparation of Positive Electrode and Positive Electrode Current Collector Terminal Plate

A strip-like positive electrode was prepared in the same manner as in Example 1. One end of the positive electrode along the longitudinal direction was provided with an edge portion (width 5 mm) where the positive electrode mixture was not applied and the positive electrode core member was exposed.

A quadrangular (rectangular) aluminum flat plate (thickness 0.5 mm) with shorter sides of approximately 10 mm and longer sides of approximately 100 mm was prepared. This aluminum flat plate was bent by press working to form three stripe-like bent portions at equal intervals in parallel with the shorter sides as illustrated in FIG. 6A, thereby obtaining a positive electrode current collector terminal plate. The height of protrusion of each bent portion was set to 0.8 mm. The gap between the pair of upstanding portions of the bent portion was set to 0.1 mm or less. The interval between the top portions of the adjacent protrusions was set to approximately 15 mm.

### (ii) Preparation of Negative Electrode and Negative Electrode Current Collector Terminal Plate

A strip-like negative electrode was prepared in the same manner as in Example 1. One end of the negative electrode along the longitudinal direction was provided with an edge portion (width 5 mm) where the negative electrode mixture was not applied and the negative electrode core member was exposed.

A quadrangular (rectangular) copper flat plate (thickness 0.3 mm) with shorter sides of approximately 10 mm and longer sides of approximately 100 mm was prepared. This copper flat plate was bent by press working to form three stripe-like bent portions at equal intervals in parallel with the shorter sides as illustrated in FIG. 6A, thereby obtaining a negative electrode current collector terminal plate. The height of protrusion of each bent portion was set to 0.5 mm. The gap between the pair of upstanding portions of the bent portion was set to 0.1 mm or less. The interval between the top portions of the adjacent protrusions was set to approximately 15 mm.

### (iii) Fabrication of Electrode Assembly and Welding of Current Collector Terminal Plate

The positive electrode plate and the negative electrode plate were wound with a separator comprising a polyethylene microporous film (thickness 20 μm) interposed therebetween, to form the electrode assembly 60 in the shape of an elliptic cylinder (flat shape) (with a thickness of approximately 10 mm, a width of approximately 100 mm, and a height of approximately 50 mm) for a prismatic lithium ion secondary battery as illustrated in FIG. 6A and FIG. 6B. At this time, the exposed edge portion of the positive electrode core member and the exposed edge portion of the negative electrode core member were allowed to protrude 3 mm from the ends of the separator on one end face and the other end face of the electrode assembly 60, respectively.

Next, the end face of the electrode assembly with the protruding exposed edge portion of the negative electrode core member was turned upward, and the negative electrode current collector terminal plate was placed on that end face. Then, a load of 500 g was applied in the direction from the negative electrode current collector terminal plate toward the electrode assembly. In this state, the protrusion of one of the bent portions of the negative electrode current collector terminal plate was melted a plurality of times from one of the longer sides toward the other longer side to perform spot welding. At this time, the negative electrode current collector terminal plate was connected to the positive terminal of a direct current TIG welding machine, while the torch of the TIG welding machine was connected to the negative terminal. The space between the protrusion of the bent portion of the negative electrode current collector terminal plate and the tip of the welding electrode was set to 1 mm, and the welding electrode was faced downward. Argon gas was released from the torch of the TIG welding machine as a shielding gas at a flow rate of 5 liters per minute, to shield the welding area. The welding current was set to 110 A. The molten metal dropped under its own weight, thereby coming into contact with the exposed edge portion of the negative electrode core member and being welded thereto.

All of the three bent portions were spot welded a plurality of times, and the electrode assembly was vertically inverted. Thereafter, the end face of the electrode assembly with the protruding exposed edge portion of the positive electrode core member was turned upward, and the positive electrode current collector terminal plate was placed on that end face. The same operations were performed, except that the welding machine was replaced with an alternating current one and that the welding current was set to 120 A.

### Example 5

Current collector terminal plates were welded to the electrode assembly of a prismatic lithium ion secondary battery in the same manner as in Example 4, except that the bent portions of the positive electrode current collector terminal plate and the negative electrode current collector terminal plate had protrusion heights of 1.0 mm and 0.7 mm, respectively.

### Example 6

Current collector terminal plates were welded to the electrode assembly of a prismatic lithium ion secondary battery in the same manner as in Example 4, except that the bent portions of the positive electrode current collector terminal plate and the negative electrode current collector terminal plate had protrusion heights of 1.3 mm and 1.0 mm, respectively.

### Comparative Example 1

Current collector terminal plates were welded to the electrode assembly of a cylindrical lithium ion secondary battery in the same manner as in Example 1, except that the positive electrode current collector terminal plate and the negative electrode current collector terminal plate were not bent by press working. The welding was performed radially at four sites.

### Comparative Example 2

Current collector terminal plates were welded to the electrode assembly of a prismatic lithium ion secondary battery in the same manner as in Example 4, except that the positive electrode current collector terminal plate and the negative electrode current collector terminal plate were not bent by press working. The welding was performed at three sites in the form of strips.

Using the cylindrical electrode assemblies of Examples 1 to 3 and Comparative Example 1 and the prismatic electrode assemblies of Examples 4 to 6 and Comparative Example 2, a peel test for their positive and negative electrode current collector terminal plates was performed to evaluate connection strength. Therein, with a tab terminal for the peel test being temporarily connected to each current collector terminal plate, and with the electrode assembly being secured, the tab terminal was pulled to measure tensile strength. Table 1 shows the relationship between tensile strength and the height of protrusion of the bent portion.

TABLE 1

| | Positive electrode | | Negative electrode | |
|---|---|---|---|---|
| | side | | side | |
| | Height of | Tensile | Height of | Tensile |
| | protrusion | strength | protrusion | strength |
| Example | (mm) | (N) | (mm) | (N) |
| 1 | 0.8 | 54 | 0.5 | 62 |
| 2 | 1.0 | 68 | 0.7 | 75 |
| 3 | 1.3 | 89 | 1.0 | 97 |
| 4 | 0.8 | 20 | 0.5 | 23 |
| 5 | 1.0 | 25 | 0.7 | 29 |
| 6 | 1.3 | 33 | 1.0 | 38 |
| Comp. Example 1 | 0 | 17 | 0 | 22 |
| Comp. Example 2 | 0 | 9 | 0 | 10 |

As shown in Table 1, it is understood that Examples 1 to 3 are superior to Comparative Example 1, with the connection strength between the exposed edge portion of the electrode core member and the current collector terminal plate being high for both the positive electrode side and the negative electrode side. It is also understood that Examples 4 to 6 are superior to Comparative Example 2, with the connection strength between the exposed edge portion of the electrode core member and the current collector terminal plate being high for both the positive electrode side and the negative electrode side.

This is because in Examples 1 to 6, a plurality of bent portions were provided for each current collector terminal plate, thereby leading to an increase in the volume of the molten metal produced by welding. Of Examples 1 to 6, Example 3 and Example 6 have particularly good connection strength. This indicates that the connection strength can be further heightened by increasing the height of protrusions of the bent portions of the current collector terminal plate.

When the volume of the molten metal produced by welding increases, the connection strength increases, so the electrical resistance of the connecting portions also becomes very low. It is thus thought that current collection is facilitated during battery use, thereby resulting in a battery suited for use at large current. It is noted that in Examples 1 to 6, the difference in connection strength between the positive electrode side and the negative electrode side is the difference attributed to the material for the current collector terminal plate and the electrode core member. Also, the difference in connection strength between the cylindrical type and the prismatic type is the difference caused by the arrangement or number of the welding sites.

### Example 7

Disc-shaped positive and negative electrode current collector terminal plates with grooves for limiting the melting range of bent portions, as illustrated in FIGS. 8A to 8D, were used. A disc-shaped aluminum flat plate (thickness 0.5 mm) having an outer diameter of approximately 30 mm and a 6-mm diameter through-hole in the center was produced. This aluminum flat plate was bent by press working to form four radial bent portions with U-shaped top portions. The height of protrusion of each bent portion was set to approximately 1 mm. The gap between the pair of upstanding portions of each bent portion was set to 0.1 mm or less. A pair of grooves (depth: approximately 0.1 mm) with a V-shaped cross-section was formed on the flat portion near the pair of upstanding portions of each bent portion, to obtain a positive electrode current collector terminal plate.

A disc-shaped copper flat plate (thickness 0.3 mm) having an outer diameter of approximately 30 mm and a 6-mm diameter through-hole in the center was produced. This copper flat plate was bent by press working to form four radial bent portions, thereby obtaining a negative electrode current collector terminal plate. The height of protrusion of each bent portion was set to approximately 1 mm. The gap between the pair of upstanding portions of each bent portion was set to 0.1 mm or less. A pair of grooves (depth: approximately 0.1 mm) with a V-shaped cross-section was formed on the flat portion near the pair of upstanding portions of each bent portion, to obtain a negative electrode current collector terminal plate.

The current collector terminal plates prepared in the above manner were welded to the electrode assembly of a cylindrical lithium ion secondary battery in the same manner as in Example 1. The whole bent portions melted, and the molten metal dropped under its own weight, thereby coming into contact with the exposed edge portion of the electrode core member and being welded thereto.

### Example 8

Disc-shaped positive and negative electrode current collector terminal plates with grooves for limiting the melting range of bent portions, as illustrated in FIGS. 9A to 9D, were used. Herein, the current collector terminal plates produced were the same as those of Example 7, except that a pair of mutually opposing grooves (depth: approximately 0.1 mm) with a V-shaped cross-section was formed on the bottom of the pair of upstanding portions of each bent portion. In the same manner as in Example 1, the current collector terminal plates were welded to the electrode assembly of a cylindrical lithium ion secondary battery. The part of each bent portion above the grooves melted, and the molten metal dropped under its own weight, thereby coming into contact with the exposed edge portion of the electrode core member and being welded thereto.

### Example 9

Rectangular positive and negative electrode current collector terminal plates with grooves for limiting the melting range of bent portions, as illustrated in FIG. 14A and FIG. 14B, were used. A quadrangular (rectangular) aluminum flat plate (thickness 0.5 mm) with shorter sides of approximately 10 mm and longer sides of approximately 100 mm was prepared. This aluminum flat plate was bent by press working to form three stripe-like bent portions at equal intervals in parallel with the shorter sides, thereby obtaining a positive electrode current collector terminal plate. The height of protrusion of each bent portion was set to approximately 1 mm. The gap between the pair of upstanding portions of the bent portion was set to 0.1 mm or less. The interval between the top portions of the adjacent protrusions was set to approximately 15 mm. A pair of grooves (depth: approximately 0.1 mm) with a V-shaped cross-section was formed on the flat portion near the pair of upstanding portions of each bent portion, to obtain a positive electrode current collector terminal plate.

A quadrangular (rectangular) copper flat plate (thickness 0.3 mm) with shorter sides of approximately 10 mm and longer sides of approximately 100 mm was prepared. This copper flat plate was bent by press working to form three stripe-like bent portions at equal intervals in parallel with the shorter sides, thereby obtaining a negative electrode current collector terminal plate. The height of protrusion of each bent portion was set to approximately 1 mm. The gap between the pair of upstanding portions of the bent portion was set to 0.1 mm or less. The interval between the top portions of the adjacent protrusions was set to approximately 15 mm. A pair of grooves (depth: approximately 0.1 mm) with a V-shaped cross-section was formed on the flat portion near the pair of upstanding portions of each bent portion, to obtain a positive electrode current collector terminal plate.

The current collector terminal plates prepared in the above manner were welded to the electrode assembly of a prismatic lithium ion secondary battery in the same manner as in Example 4. The whole bent portions melted, and the molten metal dropped under its own weight, thereby coming into contact with the exposed edge portion of the electrode core member and being welded thereto.

### Example 10

Rectangular positive and negative electrode current collector terminal plates with grooves for limiting the melting range of bent portions, as illustrated in FIG. 15A and FIG. 15B, were used. Herein, the current collector terminal plates produced were the same as those of Example 9, except that a pair of mutually opposing grooves (depth: approximately 0.1 mm) with a V-shaped cross-section was formed on the bottom of the pair of upstanding portions of each bent portion. In the same manner as in Example 4, the current collector terminal plates were welded to the electrode assembly of a prismatic lithium ion secondary battery. The part of each bent portion above the grooves melted, and the molten metal dropped under its own weight, thereby coming into contact with the exposed edge portion of the electrode core member and being welded thereto.

Using the cylindrical electrode assemblies of Examples 7 and 8 and the prismatic electrode assemblies of Examples 9 and 10, a peel test for their positive and negative electrode current collector terminal plates was performed to evaluate connection strength in the same manner as described above. Table 2 shows the results.

TABLE 2

| | Tensile strength | Tensile strength |
|---|---|---|
| | for positive | for negative |
| | electrode side | electrode side |
| Example | (N) | (N) |
| 7 | 75 | 92 |
| 8 | 70 | 85 |
| 9 | 38 | 43 |
| 10 | 35 | 40 |

As shown in Table 2, it is understood that Examples 7 and 8 are superior to Comparative Example 1, with the connection strength between the exposed edge portion of the electrode core member and the current collector terminal plate being high for both the positive electrode side and the negative electrode side. It is also understood that Examples 9 and 10 are superior to Comparative Example 2, with the connection strength between the exposed edge portion of the electrode core member and the current collector terminal plate being high for both the positive electrode side and the negative electrode side.

In Examples 7 and 8, there was a tendency for the connection strength between the exposed edge portion of the electrode core member and the current collector terminal plate to be higher than those of Examples 1 to 3 for both the positive electrode side and the negative electrode side. Also, In Examples 9 and 10, there was a tendency for the connection strength between the exposed edge portion of the electrode core member and the current collector terminal plate to be higher than those of Examples 4 to 6 for both the positive electrode side and the negative electrode side. The formation of the grooves near the bent portions limits the dissipation of heat from the bent portions to the flat portion, thereby promoting the accumulation of heat in the bent portions. Probably for this reason, the variation in the volume of the molten metal decreased, and the strength of the welded portions was stabilized. It is noted that in Examples 7 to 10, the difference in connection strength between the positive electrode side and the negative electrode side is the difference attributed to the material for the current collector terminal plate and the electrode core member. Also, the difference in connection strength between the cylindrical type and the prismatic type is the difference caused by the arrangement or number of the connection sites.

### Example 11

Disc-shaped positive and negative electrode current collector terminal plates with bent portions and low melting-point metal portions filled in the bent portions, as illustrated in FIGS. 16A to 16C, were used. A disc-shaped aluminum flat plate (thickness 0.5 mm) having an outer diameter of approximately 30 mm and a 6-mm diameter through-hole in the center was produced. This aluminum flat plate (melting point: approximately 600° C.) was bent by press working to form four radial bent portions with U-shaped top portions. The height of protrusion of each bent portion was set to approximately 1 mm. The gap between the pair of upstanding portions of each bent portion was set to approximately 0.1 mm, and aluminum alloy solder (melting point: approximately 500° C.) was filled in the gap as the low melting-point metal, to obtain a positive electrode current collector terminal plate.

A disc-shaped copper flat plate (thickness 0.3 mm) having an outer diameter of approximately 30 mm and a 6-mm diameter through-hole in the center was produced. This copper flat plate (melting point: approximately 900° C.) was bent by press working to form four radial bent portions. The height of protrusion of each bent portion was set to approximately 1 mm. The gap between the pair of upstanding portions of each bent portion was set to approximately 0.1 mm, and phosphor copper solder (melting point: approximately 700° C.) was filled in the gap as the low melting-point metal, to obtain a negative electrode current collector terminal plate.

The current collector terminal plates produced in the above manner were welded to the electrode assembly of a cylindrical secondary battery in the same manner as in Example 1, except that the welding current for the negative electrode side was set to 100 A, and that the time of spot welding was set to 50 ms for both the positive electrode side and the negative electrode side. The low melting-point metal and the bent portion melted, and the molten metal dropped under its own weight, thereby coming into contact with the exposed edge portion of the electrode core member and being welded thereto.

Using the electrode assembly equipped with the above current collection mechanism, a battery as illustrated in FIG. 3 was fabricated in the following manner. The electrode assembly 20 equipped with the current collection mechanism was inserted into the cylindrical battery case 31 with a bottom, with the negative electrode current collector terminal plate 34 facing the bottom of the battery case. The negative electrode current collector terminal plate 34 and the bottom of the battery case 31 were connected by resistance welding. The positive electrode current collector terminal plate 33 and the positive electrode lead 35 were connected by laser welding. Subsequently, the positive electrode lead 35 and the inner face of the seal plate 32 whose edge was fitted with the gasket 36 were connected by laser welding. Thereafter, a predetermined amount of a non-aqueous electrolyte (not shown) was injected into the battery case 31. Lastly, the open edge of the battery case 31 was bent inward and crimped onto the seal plate, to complete a cylindrical lithium ion secondary battery.

The lithium ion secondary battery was subjected to two initial charge/discharge cycles and then stored in a 45° C. environment for 7 days. Thereafter, the internal resistance of the lithium ion secondary battery was measured. A hundred batteries were evaluated in the same manner, and their internal resistance was found to be around 4 mΩ, which was lower than conventional values by about 10%. Further, the energy density of these lithium ion secondary batteries was measured, and it was found to be around 315 Wh/L, which was higher than conventional values by about 5%.

From the above results, it has been confirmed that according to the invention, stable welding becomes possible even when the height of an electrode core member protruding from an end face of an electrode assembly is uneven. It has also been confirmed that internal resistance can be reduced, thereby resulting in a battery suited for applications requiring the collection of large current. It has also been confirmed that the use of a low melting-point metal eliminates the need for extra space which is otherwise necessary due to the influence of heat during welding, thereby achieving high capacity.

### Example 12

Disc-shaped positive and negative electrode current collector terminal plates with pushed portions and low melting-point metal portions filled in the pushed portions, as illustrated in FIGS. 17A and 17B, were used. A disc-shaped aluminum flat plate (thickness 0.5 mm) having an outer diameter of approximately 30 mm and a 6-mm diameter through-hole in the center was produced. This aluminum flat plate (melting point: approximately 600° C.) was subjected to press working to form four radial pushed portions in which the angle formed by the flat portion and the upstanding portion was 90°. The height of protrusion of each pushed portion was set to approximately 1.5 mm. The gap between the pair of upstanding portions of each pushed portion was filled with aluminum alloy solder which was the same as the one used in Example 11, to obtain a positive electrode current collector terminal plate.

A disc-shaped copper flat plate (thickness 0.3 mm) having an outer diameter of approximately 30 mm and a 6-mm diameter through-hole in the center was produced. This copper flat plate (melting point: approximately 900° C.) was subjected to press working to form four radial pushed portions in which the angle formed by the flat portion and the upstanding portion was 90°. The height of protrusion of each pushed portion was set to approximately 1.5 mm. The gap between the pair of upstanding portions of each pushed portion was filled with phosphor copper solder which was the same as the one used in Example 11, to obtain a negative electrode current collector terminal plate.

The current collector terminal plates prepared in the above manner were welded to the electrode assembly of a cylindrical lithium ion secondary battery in the same manner as in Example 11. The low melting-point metal melted, and the molten metal dropped under its own weight, thereby coming into contact with the exposed edge portion of the electrode core member and being welded thereto. Thereafter, in the same manner as in Example 11, a cylindrical lithium ion secondary battery was produced, and evaluated in the same manner. The internal resistance was found to be around 4 mΩ, and the energy density was found to be around 315 Wh/L.

### Example 13

Disc-shaped positive and negative electrode current collector terminal plates with depressions and low melting-point metal portions filled in the depressions, as illustrated in FIGS. 18A and 18B, were used. A disc-shaped aluminum flat plate (thickness 0.5 mm) having an outer diameter of approximately 30 mm and a 6-mm diameter through-hole in the center was produced. This aluminum flat plate (melting point: approximately 600° C.) was subjected to press working to form four radial depressions with a triangular cross-section on one side. The depth and largest width of each depression were set to approximately 0.1 mm and approximately 0.2 mm, respectively. The depressions were filled with aluminum alloy solder which was the same as the one used in Example 11, to obtain a positive electrode current collector terminal plate.

A disc-shaped copper flat plate (thickness 0.3 mm) having an outer diameter of approximately 30 mm and a 6-mm diameter through-hole in the center was produced. This copper flat plate (melting point: approximately 900° C.) was subjected to press working to form four radial depressions with a triangular cross-section on one side. The depth and largest width of each depression were set to approximately 0.1 mm and approximately 0.2 mm, respectively. The depressions were filled with phosphor copper solder which was the same as the one used in Example 11, to obtain a negative electrode current collector terminal plate.

The current collector terminal plates prepared in the above manner were welded to the electrode assembly of a cylindrical lithium ion secondary battery in the same manner as in Example 11. The whole low melting-point metal melted, and the molten metal dropped under its own weight, thereby coming into contact with the exposed edge portion of the electrode core member and being welded thereto. Thereafter, in the same manner as in Example 11, a cylindrical lithium ion secondary battery was produced, and evaluated in the same manner. The internal resistance was found to be around 4 mΩ, and the energy density was found to be around 315 Wh/L.

### Example 14

Disc-shaped positive and negative electrode current collector terminal plates with cut-away portions and low melting-point metal portions filled in the cut-away portions, as illustrated in FIGS. 19A and 19B, were used. A disc-shaped aluminum flat plate (thickness 0.5 mm) having an outer diameter of approximately 30 mm and a 6-mm diameter through-hole in the center was produced. This aluminum flat plate (melting point: approximately 600° C.) was cut to form four radial cut-away portions with a width of approximately 2 mm and a length from the outer edge toward the center of approximately 5 mm. Aluminum alloy solder which was the same as the one used in Example 11 was filled in the cut-away portions in such a manner that it was flush with the aluminum flat plate, to obtain a positive electrode current collector terminal plate.

A disc-shaped copper flat plate (thickness 0.3 mm) having an outer diameter of approximately 30 mm and a 6-mm diameter through-hole in the center was produced. This copper flat plate (melting point: approximately 900° C.) was cut to form four radial cut-away portions with a width of approximately 2 mm and a length from the outer edge toward the center of approximately 5 mm. Phosphor copper solder which was the same as the one used in Example 11 was filled in the cut-away portions in such a manner that it was flush with the copper flat plate, to obtain a negative electrode current collector terminal plate.

The current collector terminal plates prepared in the above manner were welded to the electrode assembly of a cylindrical lithium ion secondary battery in the same manner as in Example 11. The whole low melting-point metal melted, and the molten metal dropped under its own weight, thereby coming into contact with the exposed edge portion of the electrode core member and being welded thereto. Thereafter, in the same manner as in Example 11, a cylindrical lithium ion secondary battery was produced, and evaluated in the same manner. The internal resistance was found to be around 3.5 mΩ, which is lower than conventional values by about 20%, and the energy density was found to be around 315 Wh/L. It is believed that more stable connection became possible because the low melting-point metal was filled in the cut-away portions, thereby leading to an increase in the volume of the low melting-point metal and the molten metal filled between the electrode assembly and the current collector terminal plates, compared with Examples 11 to 13.

### Example 15

Disc-shaped positive and negative electrode current collector terminal plates with cut-away portions and low melting-point metal portions filled in the cut-away portions, as illustrated in FIGS. 20A and 20B, were used. Herein, the positive electrode current collector terminal plate produced was the same as that of Example 14, except that aluminum alloy solder was filled in the cut-away portions so as to protrude from one side. Also, the negative electrode current collector terminal plate produced was the same as that of Example 14, except that phosphor copper solder was filled in the cut-away portions so as to protrude from one side of the current collector terminal plate. In each of the positive electrode current collector terminal plate and the negative electrode current collector terminal plate, the volume of the low melting-point metal portions was made approximately 2 to 3 times that of Example 14.

The current collector terminal plates prepared in the above manner were welded to the electrode assembly of a cylindrical secondary battery in the same manner as in Example 11. The whole low melting-point metal melted, and the molten metal dropped under its own weight, thereby coming into contact with the exposed edge portion of the electrode core member and being welded thereto. Thereafter, in the same manner as in Example 11, a cylindrical lithium ion secondary battery was produced, and evaluated in the same manner. The internal resistance was found to be around 3 mΩ, which was lower than conventional values by about 30%, and the energy density was found to be around 315 Wh/L. It is believed that more stable connection became possible because the amount of the low melting-point metal was increased, thereby leading to an increase in the molten metal filled between the electrode assembly and the current collector terminal plates, compared with Examples 11 to 14.

### Example 16

Disc-shaped positive and negative electrode current collector terminal plates with through-holes and low melting-point metal portions filled in the through-holes, as illustrated in FIGS. 21A and 21B, were used. A disc-shaped aluminum flat plate (thickness 0.5 mm) having an outer diameter of approximately 30 mm and a 6-mm diameter through-hole in the center was produced. Further, this aluminum flat plate (melting point: approximately 600° C.) was provided with radial rows of small through-holes with a diameter of approximately 2 mm, each row consisting of three small through-holes (a total of 12). Aluminum alloy solder which was the same as the one used in Example 11 was filled in the small through-holes in such a manner that it was flush with the aluminum flat plate, to obtain a positive electrode current collector terminal plate.

A disc-shaped copper flat plate (thickness 0.3 mm) having an outer diameter of approximately 30 mm and a 6-mm diameter through-hole in the center was produced. Further, this copper flat plate (melting point: approximately 900° C.) was provided with radial rows of small through-holes with a diameter of approximately 2 mm, each row consisting of three small through-holes (a total of 12). Phosphor copper solder which was the same as the one used in Example 11 was filled in the small through-holes in such a manner that it was flush with the copper flat plate, to obtain a negative electrode current collector terminal plate.

The current collector terminal plates prepared in the above manner were welded to the electrode assembly of a cylindrical lithium ion secondary battery in the same manner as in Example 11. The whole low melting-point metal melted, and the molten metal dropped under its own weight, thereby coming into contact with the exposed edge portion of the electrode core member and being welded thereto. Thereafter, in the same manner as in Example 11, a cylindrical lithium ion secondary battery was produced, and evaluated in the same manner. The internal resistance was found to be around 3.5 mΩ, which was lower than conventional values by about 20%, and the energy density was found to be around 315 Wh/L. It is believed that more stable connection became possible because the low melting-point metal was filled in the through-holes, thereby leading to an increase in the volume of the low melting-point metal and the molten metal filled between the electrode assembly and the current collector terminal plates, compared with Examples 11 to 13.

### Example 17

Disc-shaped positive and negative electrode current collector terminal plates with through-holes and low melting-point metal portions filled in the through-holes, as illustrated in FIGS. 22A and 22B, were used. Herein, the positive electrode current collector terminal plate produced was the same as that of Example 16, except that aluminum alloy solder was filled in the small through-holes so as to protrude from one side. Also, the negative electrode current collector terminal plate produced was the same as that of Example 16, except that phosphor copper solder was filled in the small through-holes so as to protrude from one side of the current collector terminal plate. In each of the positive electrode current collector terminal plate and the negative electrode current collector terminal plate, the volume of the low melting-point metal portions was made approximately 2 to 3 times that of Example 16.

The current collector terminal plates prepared in the above manner were welded to the electrode assembly of a cylindrical lithium ion secondary battery in the same manner as in Example 11. The whole low melting-point metal melted, and the molten metal dropped under its own weight, thereby coming into contact with the exposed edge portion of the electrode core member and being welded thereto. Thereafter, in the same manner as in Example 11, a cylindrical lithium ion secondary battery was produced, and evaluated in the same manner. The internal resistance was found to be around 3 mΩ, which was lower than conventional values by about 30%, and the energy density was found to be around 315 Wh/L. It is believed that more stable connection became possible because the amount of the low melting-point metal was increased, thereby leading to an increase in the molten metal filled between the electrode assembly and the current collector terminal plates, compared with Examples 11 to 14 and 16.

### INDUSTRIAL APPLICABILITY

The secondary battery of the invention has a large connection area between the electrode assembly and a current collector terminal plate, providing a highly reliable current collection structure. Therefore, it is particularly suited for applications requiring large current or applications requiring resistance to vibration or impact. The secondary battery of the invention is effective, for example, as the power source for cordless power tools, motor assisted bicycles, and hybrid vehicles. Also, according to the invention, since a current collection structure can be formed at relatively low temperatures, there is no need to provide the battery with extra space that is otherwise necessary due to the influence of heat. Accordingly, the invention is suitable for battery applications requiring space saving and high capacity.

1. A current collector terminal plate for a secondary battery, comprising a plate-shaped conductive material, the conductive material having an expected welding portion that melts with priority.

2. The current collector terminal plate for a secondary battery in accordance with claim 1, wherein the conductive material has a bent portion forming a protrusion on one side and a depression on the other side and a flat portion, and the expected welding portion includes the bent portion.

3. The current collector terminal plate for a secondary battery in accordance with claim 2, wherein the bent portion has a pair of upstanding portions raised from the flat portion and a bent top portion extending continuously from the pair of upstanding portions.

4. The current collector terminal plate for a secondary battery in accordance with claim 3, wherein a gap is formed between the pair of upstanding portions.

5. The current collector terminal plate for a secondary battery in accordance with claim 3, wherein a groove for limiting a melting range of the bent portion is formed on each of the pair of upstanding portions or on the flat portion near each of the pair of upstanding portions.

6. The current collector terminal plate for a secondary battery in accordance with claim 5, wherein a cross-sectional shape of the groove is V shape, wedge shape, U shape, semicircular shape, rectangular shape, or trapezoidal shape.

7. The current collector terminal plate for a secondary battery in accordance with claim 1, wherein the conductive material has a first metal portion forming a main portion and a second metal portion with a lower melting point than the first metal portion, and the expected welding portion includes the second metal portion.

8. The current collector terminal plate for a secondary battery in accordance with claim 7, wherein the first metal portion has a depression on one side, and the second metal portion is disposed in the depression.

9. The current collector terminal plate for a secondary battery in accordance with claim 8, wherein the first metal portion has a bent portion forming the depression on one side and a protrusion on the other side and a flat portion.

10. The current collector terminal plate for a secondary battery in accordance with claim 9, wherein the bent portion has a pair of upstanding portions raised from the flat portion and a bent top portion extending continuously from the pair of upstanding portions, a gap is formed between the pair of upstanding portions, and the second metal portion is disposed in the gap.

11. The current collector terminal plate for a secondary battery in accordance with claim 7, wherein the first metal portion has a cut-away portion, and the second metal portion is filled in the cut-away portion.

12. The current collector terminal plate for a secondary battery in accordance with claim 11, wherein the second metal portion protrudes from the first metal portion.

13. The current collector terminal plate for a secondary battery in accordance with claim 7, wherein the first metal portion has a through-hole in a thickness direction of the current collector terminal plate, and the second metal portion is filled in the through-hole.

14. The current collector terminal plate for a secondary battery in accordance with claim 13, wherein the second metal portion protrudes from the first metal portion.

15. The current collector terminal plate for a secondary battery in accordance with claim 1, wherein the current collector terminal plate is in the shape of a disc or a rectangle when seen from a thickness direction thereof.

16. The current collector terminal plate for a secondary battery in accordance with claim 1, wherein the conductive material includes a portion made of copper, a copper alloy, aluminum, an aluminum alloy, nickel, a nickel alloy, or a nickel-plated steel plate.

17. A secondary battery precursor comprising:
an electrode assembly comprising a first electrode and a second electrode which are wound or laminated with a separator interposed therebetween, the electrode assembly having a first end face and a second end face which are opposite to each other;
a first current collector terminal plate to be disposed on the first end face and electrically connected to the first electrode; and
a second current collector terminal plate to be disposed on the second end face and electrically connected to the second electrode,
wherein the first electrode includes a first core member and a first active material layer adhering to the first core member and has an exposed edge portion of the first core member which is to be disposed on the first end face and welded to the first current collector terminal plate,
the second electrode includes a second core member and a second active material layer adhering to the second core member and has an exposed edge portion of the second core member which is to be disposed on the second end face and welded to the second current collector terminal plate, and
at least one of the first current collector terminal plate and the second current collector terminal plate is the current collector terminal plate of claim 1 having the expected welding portion.

18. The secondary battery precursor in accordance with claim 17,
wherein the current collector terminal plate having the expected welding portion is the current collector terminal plate of claim 2 comprising the plate-shaped conductive material, the conductive material having the bent portion forming the protrusion on one side and the depression on the other side and the flat portion, the expected welding portion including the bent portion, and
the depression faces the first end face or the second end face.

19. The secondary battery precursor in accordance with claim 17, wherein the bent portion has a pair of upstanding portions raised from the flat portion and a bent top portion extending continuously from the pair of upstanding portions.

20. The secondary battery precursor in accordance with claim 17,
wherein the current collector terminal plate having the expected welding portion is the current collector terminal plate of claim 7 comprising the plate-shaped conductive material, the conductive material having the first metal portion forming the main portion and the second metal portion with a lower melting point than the first metal portion, the expected welding portion including the second metal portion, and
the second metal portion faces the first end face or the second end face.

21. The secondary battery precursor in accordance with claim 20, wherein the first metal portion has a depression on a face facing the first end face or the second end face, and the second metal portion is disposed in the depression.

22. The secondary battery precursor in accordance with claim 20, wherein the second metal portion protrudes from the first metal portion toward a side opposite to a face facing the first end face or the second end face.

23. The secondary battery precursor in accordance with claim 17,
wherein the current collector terminal plate is in the shape of a disc or a rectangle when seen from a thickness direction thereof,
when the current collector terminal plate is in the shape of a disc, the expected welding portions are disposed radially, and
when the current collector terminal plate is in the shape of a rectangle, the expected welding portions are disposed in a direction intersecting with longer sides thereof.

24. A secondary battery comprising:
an electrode assembly comprising a first electrode and a second electrode which are wound or laminated with a separator interposed therebetween, the electrode assembly having a first end face and a second end face which are opposite to each other;
an electrolyte;
a cylindrical battery case having a bottom and housing the electrode assembly and the electrolyte;
a seal plate for sealing the battery case;
a first current collector terminal plate disposed on the first end face and electrically connected to the first electrode; and
a second current collector terminal plate disposed on the second end face and electrically connected to the second electrode,
wherein the first electrode includes a first core member and a first active material layer adhering to the first core member and has an exposed edge portion of the first core member which is disposed on the first end face and welded to the first current collector terminal plate,
the second electrode includes a second core member and a second active material layer adhering to the second core member and has an exposed edge portion of the second core member which is disposed on the second end face and welded to the second current collector terminal plate, and
at least one of the first current collector terminal plate and the second current collector terminal plate is a deformed version of the current collector terminal plate of claim 1 having the expected welding portion, in which the expected welding portion is deformed and in contact with the exposed edge portion of the first core member or the second core member.

25. The secondary battery in accordance with claim 24,
wherein the deformed version is a deformed version of the current collector terminal plate of claim 2 comprising the plate-shaped conductive material, the conductive material having the bent portion forming the protrusion on one side and the depression on the other side and the flat portion, the expected welding portion including the bent portion,
said the other side faces the first end face or the second end face, and
the bent portion is deformed and in contact with the exposed edge portion of the first core member or the second core member.

26. The secondary battery in accordance with claim 25,
wherein the bent portion has a pair of upstanding portions raised from the flat portion and a bent top portion extending continuously from the pair of upstanding portions, and
a groove for limiting a melting range of the bent portion is formed on each of the pair of upstanding portions or on the flat portion near each of the pair of upstanding portions.

27. The secondary battery in accordance with claim 26, wherein a cross-sectional shape of the groove is V shape, wedge shape, U shape, semicircular shape, rectangular shape, or trapezoidal shape.

28. The secondary battery in accordance with claim 24,
wherein the deformed version is a deformed version of the current collector terminal plate of claim 7 comprising the plate-shaped conductive material, the conductive material having the first metal portion forming the main portion and the second metal portion with a lower melting point than the first metal portion, the expected welding portion including the second metal portion,
the second metal portion faces the first end face or the second end face, and
the second metal portion is deformed and in contact with the exposed edge portion of the first core member or the second core member.

29. The secondary battery in accordance with claim 24,
wherein the deformed version is in the shape of a disc or a rectangle when seen from a thickness direction of the deformed version,
when the deformed version is in the shape of a disc, the expected welding portions are disposed radially, deformed, and in contact with the exposed edge portion of the first core member or the second core member, and
when the deformed version is in the shape of a rectangle, the expected welding portions are disposed in a direction intersecting with longer sides thereof, deformed, and in contact with the exposed edge portion of the first core member or second core member.

30. A method for producing a secondary battery, comprising the steps of:
(i) providing a first electrode having a first core member and a first active material layer adhering to the first core member, the first electrode having an exposed edge portion of the first core member;
(ii) providing a second electrode having a second core member and a second active material layer adhering to the second core member, the second electrode having an exposed edge portion of the second core member;
(iii) winding or laminating the first electrode and the second electrode with a separator interposed therebetween to form an electrode assembly having a first end face and a second end face which are opposite to each other, wherein the exposed edge portion of the first core member is disposed on the first end face and the exposed edge portion of the second core member is disposed on the second end face;
(iv) disposing a first current collector terminal plate, to be electrically connected to the first electrode, on the first end face, and welding the first current collector terminal plate to the exposed edge portion of the first core member; and
(v) disposing a second current collector terminal plate, to be electrically connected to the second electrode, on the second end face, and welding the second current collector terminal plate to the exposed edge portion of the second core member,
wherein at least one of the first current collector terminal plate and the second current collector terminal plate is the current collector terminal plate of claim 1 having the expected welding portion, and
step (iv) or (v) comprises disposing the expected welding portion so as to face the first end face or the second end face and melting the expected welding portion such that a molten material comes into contact with the exposed edge portion of the first core member or the second core member.

31. The method for producing a secondary battery in accordance with claim 30,
wherein the current collector terminal plate having the expected welding portion is the current collector terminal plate of claim 2 comprising the plate-shaped conductive material, the conductive material having the bent portion forming the protrusion on one side and the depression on the other side and the flat portion, the expected welding portion including the bent portion, and
the molten material is produced by disposing the depression so as to face the first end face or the second end face and melting the bent portion.

32. The method for producing a secondary battery in accordance with 31, wherein the bent portion is formed by bending.

33. The method for producing a secondary battery in accordance with claim 32, wherein the bending is performed by press working.

34. The method for producing a secondary battery in accordance with claim 31, wherein the bent portion has a pair of upstanding portions raised from the flat portion and a bent top portion extending continuously from the pair of upstanding portions.

35. The method for producing a secondary battery in accordance with claim 34, wherein a groove for limiting a melting range of the bent portion is formed on each of the pair of upstanding portions or on the flat portion near each of the pair of upstanding portions.

36. The method for producing a secondary battery in accordance with claim 34, wherein a gap is formed between the pair of upstanding portions, and the molten material is brought into contact with the exposed edge portion of the first core member or the second core member through the gap.

37. The method for producing a secondary battery in accordance with claim 30, wherein the current collector terminal plate having the expected welding portion is the current collector terminal plate of claim 7 comprising the plate-shaped conductive material, the conductive material having the first metal portion forming the main portion and the second metal portion with a lower melting point than the first metal portion, the expected welding portion including the second metal portion, and
the molten material is produced by disposing the second metal portion so as to face the first end face or the second end face and melting the second metal portion.

38. The method for producing a secondary battery in accordance with claim 30, wherein the expected welding portion is melted by TIG welding.
